(19) United States
(12) Patent Application Publication
(10) Pub. No.: US 2026/0008148 A1
(43) Pub. Date: Jan. 8, 2026

(54) GRINDER

(71) Applicant: MAKITA CORPORATION, ANJO-SHI (JP)

(72) Inventors: Takahiro KAWAKAMI, ANJO-SHI (JP); Yu ETO, ANJO-SHI (JP); Yuto NAKADORI, ANJO-SHI (JP)

(21) Appl. No.: 19/256,248

(22) Filed: Jul. 1, 2025

(30) Foreign Application Priority Data
Jul. 8, 2024 (JP) 2024-109424
Jul. 8, 2024 (JP) 2024-109425
Jul. 8, 2024 (JP) 2024-109426

(51) Int. Cl. B24B 23/02; B25F 5/00; B25F 5/02

(52) U.S. Cl. CPC B24B 23/028; B24B 23/022; B25F 5/001; B25F 5/02

(57) ABSTRACT

A grinder includes: an electric motor having a motor shaft extending in a first direction; a final output shaft extending in a second direction orthogonal to the first direction and on which a tool accessory is mountable; first and second bearings that rotatably support the final output shaft, the second bearing that being located closer to the tool accessory in the second direction than the first bearing; a gear housing having a first through-hole, which passes through the gear housing in the second direction has a female thread; a bearing box that supports the second bearing and has a second through-hole passing through the second through-hole in the second direction coaxially with the first through-hole; and a screw threadedly engaged with the first through-hole and is inserted in the direction from the bearing box toward the gear housing to fixes the gear housing and the bearing box to each other.

### CROSS-REFERENCE

The present application claims priority to Japanese patent application serial numbers 2024-109424, 2024-109425 and 2024-109426, all filed on Jul. 8, 2024, the contents of all of which are fully incorporated herein by reference.

### TECHNICAL FIELD

The present invention relates to a grinder.

### BACKGROUND ART

Grinders are known as one type of portable power tool. A grinder is a tool that can perform various types of machining work by transmitting the rotational driving force of a motor shaft of a motor to a spindle to rotationally drive a tool accessory mounted on the spindle. For example, a grinder having a layout in which the motor shaft and the spindle are orthogonal is known as one type of such a grinder. Such a grinder is also called an angle grinder. Among angle grinders, a type of grinder having a thin head portion (that is, a thin portion around the spindle) is known as a flat-head grinder (see, for example, US 2012/282846). Flat-head grinders enable the head portion to be inserted into narrow locations, where the height to which the head portion is inserted (in other words, the width in the direction in which the spindle extends in the attitude in which the grinder is being used) is constrained (limited), to perform machining at such locations.

### SUMMARY OF THE INVENTION

To increase the convenience of using such a flat-head grinder, it is one non-limiting object of the present teachings to disclose techniques for reducing the thickness of the head portion.

In a first aspect of the present teachings, a grinder may comprise: an electric motor having a motor shaft that extends in a first direction; a final output shaft that extends in a second direction orthogonal to the first direction and on which a tool accessory is mountable; a first bearing that supports the final output shaft in a rotatable manner; a second bearing that is located closer to the tool accessory in the second direction than the first bearing and also supports the final output shaft in a rotatable manner; at least one gear that is configured to transmit the rotational driving force (rotational energy) of the motor shaft to the final output shaft; a gear housing that at least partially houses the at least one gear and has a first through-hole, which passes through the gear housing in the second direction on the side opposite the electric motor with respect to the final output shaft in the first direction, the first through-hole having a female thread; a bearing box that is located closer to the tool accessory in the second direction than the gear housing, supports the second bearing, and has a second through-hole that passes through the bearing box in the second direction coaxially with the first through-hole; and a screw that is threadedly engaged with the first through-hole and, in a state (an orientation) of being inserted in the direction from the bearing box toward the gear housing, fixes the gear housing and the bearing box to each other.

In this grinder, the first through-hole is in the form of a through-hole that passes through the gear housing in the second direction. Consequently, if the first through-hole is formed in the gear housing using a tap drill during the manufacture of the grinder, the first through-hole can be formed so that an incomplete thread portion is not present.

Therefore, as compared with previously existing grinders in which a screw hole corresponding to the first through-hole is formed as a blind screw hole, the thickness of the gear housing at the location of the first through-hole (i.e., the thickness of the head portion that will be inserted at (into) a narrow location where height (space) is constrained (limited)) can be reduced by (i) the length of the incomplete thread portion and (plus) (ii) a thickness corresponding to the wall thickness of the gear housing that would be required to close off (cover) the screw hole. As a result of this design, the head portion can be made narrower so that it can be inserted into locations having greater height constraints (i.e. narrower locations) to perform machining, thereby improving convenience for the user and increasing opportunities for using the grinder.

In a second aspect of the present teachings, a grinder may comprise: an electric motor having a motor shaft that extends in a first direction; a tool accessory; a final output shaft that extends in a second direction orthogonal to the first direction and on which the tool accessory is mountable; a first bearing that supports the final output shaft in a rotatable manner; a second bearing that is located closer to the tool accessory in the second direction than is the first bearing and also supports the final output shaft in a rotatable manner; at least one gear that is configured to transmit the rotational driving force (rotational energy) of the motor shaft to the final output shaft; and a gear housing that at least partially houses the at least one gear. The side on which the final output shaft is located in the first direction and the side on which the electric motor is located in the first direction are defined as the front side and the rear side, respectively. The side on which the first bearing is located and the side on which the second bearing is located in the second direction are defined as the upper side and the lower side, respectively. An access angle is formed by an angle formed by a first straight line, which extends rearward and upward from the front-side and the upper-side edge portion of the tool accessory and is tangent to the gear housing as viewed in a direction orthogonal to the front-rear direction and the up-down direction, and a second straight line, which extends rearward and downward from the front-side and the lower-side edge portion of the tool accessory and is tangent to a component part of the grinder as viewed in a direction orthogonal to the front-rear direction and the up-down direction. The access angle may be less than 42°.

In this grinder, because the access angle is less than 42°, the thickness of the head portion can be made smaller (thinner) than previously existing flat-head grinders that have an access angle of 42° or greater.

### BRIEF DESCRIPTION OF THE DRAWINGS

FIG. 1 is an oblique view of a grinder according to a first embodiment of the present teachings.

FIG. 2 is a plan view of the grinder.

FIG. 3 is a partial cross-sectional view of the grinder.

FIG. 4 is a partial enlarged view of FIG. 3.

FIG. 5 is a partial enlarged view of FIG. 3.

FIG. 6 is a partial, longitudinal, cross-sectional view of the grinder along line A-A in FIG. 2.

FIG. 7 is a partial left view of the grinder.

FIG. 8 is a partial, transverse, cross-sectional view of the grinder.

FIG. 9 is an oblique view of a bearing box.

FIG. 10 is an oblique view of a cover.

FIG. 11 is a partial, longitudinal, cross-sectional view of the grinder along line B-B in FIG. 8.

FIG. 12 is a longitudinal cross-sectional view of the grinder along line B-B in FIG. 7.

FIG. 13 is an oblique view showing one example of the cover in a mounted state.

FIG. 14 is an oblique view showing the structure of the lower side of the grinder, with the cover and a tool accessory removed.

FIG. 15 is an oblique view of the grinder with a pressing member in FIG. 14 removed.

FIG. 16 is an oblique view of the grinder with a sealing member in FIG. 15 removed.

FIG. 17 is a side view of a lead washer.

FIG. 18 is a transverse cross-sectional view of a spindle and an inner flange when an electric motor is being driven.

FIG. 19 is a transverse cross-sectional view of the spindle and the inner flange showing a maximum range of relative rotation of the spindle and the inner flange.

FIG. 20 is a transverse cross-sectional view of the spindle and the inner flange according to a second embodiment of the present teachings when the electric motor is being driven.

FIG. 21 is a transverse cross-sectional view of the spindle and the inner flange according to the second embodiment showing a maximum range of relative rotation of the spindle and the inner flange.

### DETAILED DESCRIPTION OF THE INVENTION

Representative and non-limiting concrete examples of the present invention are described below in detail, with reference to the drawings. This detailed description is merely intended to indicate to a person skilled in the art the details for implementing presently preferred examples of the present invention and is not intended to limit the scope of the present invention. In addition, the additional features and inventions disclosed below can also be used separately from, or in conjunction with, other features and inventions to provide further improved devices, manufacturing methods, and methods of use.

In addition, combinations of features or processes disclosed in the detailed description below are not essential when implementing the present invention in the broadest possible meaning and are only described for explaining representative concrete examples of the present invention in detail. Moreover, when providing additional, useful embodiments of the present invention, various features of the above-mentioned and below-mentioned representative concrete examples as well as various features that are described in the independent and dependent claims need not be as described in the concrete examples recited herein nor combined in the order enumerated.

Separately from the configurations of the features described in the embodiments and/or the claims, all the features described in the present specification and/or the claims are intended to be disclosed individually and independently as limitations on the specific matters disclosed and claimed at the time of filing. Moreover, the descriptions related to all numerical ranges and groupings or categories are intended to disclose intermediate configurations thereof as limitations on the specific matters disclosed and claimed at the time of filing.

In one or more embodiments, the screw may be disposed within the first through-hole such that a tip of the screw reaches a depth having a distance of greater than 0 mm and less than 1 mm from an edge portion on the side of the first through-hole opposite the tool accessory in the second direction. According to this configuration, the tip of the screw (the end portion on the opposite side from the head portion of the screw) does not project from (out of) the upper surface of the gear housing. Accordingly, the tip of the screw can be prevented from getting caught on a user's finger or the workpiece while still being able to reduce the thickness of the head portion of the grinder as much as possible.

In one or more embodiments, an edge portion on the side of the first through-hole opposite the tool accessory in the second direction may have a countersunk (funnel or truncated cone) shape. During the manufacture of the grinder, the first through-hole is typically formed using a tap drill after the gear housing has been cast and then coated. Therefore, according to the above-mentioned configuration, if a gear housing having a countersunk shape around the location where the first through-hole is formed is made (cast) with a die, the gear housing is then coated and thereafter the first through-hole is formed using a tap drill, then the coating on (along, around) the edge portion of the first through-hole on the opposite side from the tool accessory will be less likely to peel off when the first through-hole is being formed.

In one or more embodiments, the first through-hole may include a first-side through-hole and a second-side through-hole disposed spaced apart in a third direction that is orthogonal to the first direction and the second direction. The screw may include a first-side screw inserted into the first-side through-hole and a second-side screw inserted into the second-side through-hole. In a cross section passing through the axis of the first-side screw and the axis of the second-side screw, the edge portions of the first-side through-hole and the second-side through-hole on the sides opposite the tool accessory in the second direction may be located closer to the tool accessory in the second direction than a center portion of the outer surface of the gear housing between the first-side through-hole and the second-side through-hole. According to this configuration, the height of the gear housing in the head portion can be made smaller (thinner) in the third direction at both end portions than at the center portion. Consequently, when the grinder is being used by inserting the head portion into a narrow location where height (space) is constrained (limited), the head portion is less likely to get caught on surrounding obstacles even if machining work is performed while (manually) pivoting the head portion in the third direction (in other words, pivoting about the axis of the final output shaft).

In a third aspect of the present teachings, a grinder may comprise: an electric motor having a motor shaft that extends in a first direction; a final output shaft that extends in a second direction orthogonal to the first direction and on which the tool accessory is mountable; a first bearing that supports the final output shaft in a rotatable manner; a second bearing that is located closer to the tool accessory in the second direction than is the first bearing and supports the final output shaft in a rotatable manner; at least one gear that is configured to transmit rotational driving force of the motor shaft to the final output shaft; a gear housing that at least partially houses the at least one gear; a bearing box that is fixed to the gear housing and supports the second bearing; and a cover that is configured to be mountable on the bearing box in a detachable manner and partially covers the tool accessory in an arcuate shape along the circumferential direction relative to the final output shaft. The side on which the first bearing is located and the side on which the second bearing is located in the second direction are defined as the upper side and the lower side, respectively. The bearing box may comprise: a plurality of first protruding portions that protrude radially outward, relative to the final output shaft, on the lower-side edge portion of the bearing box such that a groove extending at least partially in the circumferential direction is formed, the first protruding portions being spaced apart in the circumferential direction; and first recessed portions respectively located (defined) between the first protruding portions in the circumferential direction. The cover may comprise: a plurality of second protruding portions, the radial centers of which have substantially arcuate notched shapes, and which protrude radially inward on the radially inner-side edge portion of the cover, the second protruding portions being spaced apart in the circumferential direction; and second recessed portions respectively located (defined) between the second protruding portions in the circumferential direction. The grinder may be configured such that: when the first protruding portions and the second recessed portions are respectively at corresponding rotational-angle positions and the second protruding portions and the first recessed portions are respectively at corresponding rotational-angle positions, the cover can be disposed on the bearing box from below at an insertion position, which is a position at which the second protruding portions are located upward of the first protruding portions in the second direction and the cover surrounds the bearing box in the circumferential direction. Thereafter, when the cover is rotated from the insertion position relative to the bearing box and the first protruding portions and the second protruding portions are respectively at corresponding rotational-angle positions, the second protruding portions are accommodated within the groove and the first protruding portions and the second protruding portions respectively engage with (contact) each other in the up-down direction.

With previously existing flat-head grinders, a cover mounting structure, which is utilized in ordinary, non-flat-head-type grinders, cannot be used. Specifically, in said cover mounting structure, the bearing box mounted on the gear housing has a tubular mount (hereinafter also referred to as a first mount). The cover comprises a ring-shaped mount (hereinafter also referred to as a second mount) that extends from the upper surface of the cover (the surface thereof farthest from the tool accessory) toward the opposite side from the tool accessory. The cover is fixed to the bearing box by mounting the second mount around the first mount. Such a cover mounting structure cannot be utilized in a flat-head grinder because the height of the head portion of the grinder will be increased by the height of the first mount and the second mount.

On the other hand, according to the above-described grinder of the third aspect of the present teachings, a new cover mounting structure suitable for flat-head grinders is provided. Specifically, the cover of the third aspect of the present teachings can be mounted in the following manner. First, the cover is disposed at an insertion position relative to the bearing box from below such that the second protruding portions of the cover respectively pass through the first recessed portions of the bearing box and the first protruding portions of the bearing box respectively pass through the second recessed portions of the cover. The cover is then rotated relative to the bearing box from the insertion position to a rotational-angle position at which the first protruding portions and the second protruding portions correspond (are aligned) with each other. The first protruding portions of the bearing box and the second protruding portions of the cover are thereby engaged (in contact) with each other in the up-down direction, and thus the cover can be fixed to the bearing box in the state such that the cover will not come off in the up-down direction.

In a fourth aspect of the present teachings, a grinder may comprise: an electric motor having a motor shaft that extends in a first direction; a final output shaft that extends in a second direction orthogonal to the first direction and on which the tool accessory is mountable; a first bearing that supports the final output shaft in a rotatable manner; a second bearing that is located closer to the tool accessory in the second direction than is the first bearing and also supports the final output shaft in a rotatable manner; a bearing box that supports the second bearing; and a cover that is configured to be mountable on the bearing box in a detachable manner and partially covers the tool accessory in an arcuate shape along the circumferential direction relative to the final output shaft. The side on which the first bearing is located and the side on which the second bearing is located in the second direction are defined as the upper side and the lower side, respectively. The bearing box may have a cover mounting portion on the lower-side edge portion of the bearing box. The cover may have a shape such that the center thereof in the radial direction is notched in a substantially arcuate shape. The cover may be configured to be rotatable relative to the cover mounting portion between a first position, at which the cover can be fitted upward into the cover mounting portion from below such that the cover surrounds the cover mounting portion in the circumferential direction, and a second position, at which the cover and the cover mounting portion partially engage in the up-down direction.

According to the grinder of the fourth aspect, the cover can be mounted in the following manner. First, the cover is fitted upward into the cover mounting portion from below and disposed at the first position. The cover is then rotated relative to the cover mounting portion from the first position to the second position. Because the cover mounting portion of the bearing box and the cover are thereby engaged in the up-down direction, the cover can be fixed to the bearing box in the state such that the cover will not come off in the up-down direction.

In one or more embodiments, the first protruding portions and the second protruding portions may be configured so that the rotational-angle positions of the bearing box and the cover at the insertion position are uniquely determined. According to this configuration, when the user rotates the cover from the insertion position to the rotational-angle positions at which the first protruding portion and the second protruding portion correspond, the cover does not unintentionally come off the bearing box in the up-down direction.

In one or more embodiments, the radially inward edge portion of the cover may have an open shape that is partially notched in the circumferential direction. According to this configuration, the user can perform cutting work by holding the grinder in an attitude such that the notch portion of the cover opposes the workpiece (for such cutting work, a cutting wheel is typically used as the tool accessory). In this way, cutting depth can be made larger than in an embodiment in which the radially inward edge portion of the cover has a closed shape.

In one or more embodiments, the two second protruding portions, among the plurality of second protruding portions, that are spaced farthest apart in the circumferential direction may be spaced apart at (by) an angle greater than 180° in the circumferential direction along the radially inward edge portion of the cover. According to this configuration, even if the cover is displaced in a direction such that the notch in the cover approaches the final output shaft, the side surfaces of the two second protruding portions engage with the bearing box, thereby preventing the cover from coming off the bearing box in the horizontal direction and also restricting movement of the cover in the horizontal direction. In addition, in known grinders of this type, it is common to provide a retaining mechanism (or a horizontal-movement-restricting mechanism) at a location corresponding to the diameter of the cover (in other words, the diameter of the tool accessory) for each model of the grinder (more specifically, models having different tool accessory diameters). On the other hand, according to the above-mentioned configuration of the present teachings, because the shape of the cover can be used to achieve both retention in the horizontal direction and restriction of movement in the horizontal direction, multiple covers having different diameters can be selectively mounted on a single grinder. In other words, as long as the apparatus layout is configured such that a cover having the largest diameter among the plurality of covers having different diameters does not interfere with the other parts of the grinder, then, during the manufacture, a common main body can be used for a plurality of models of the grinder, each comprising a plurality of covers having different diameters. As a result, the cost of manufacturing multiple types of the grinder can be reduced.

In one or more embodiments, the cover may comprise: a cover upper portion that extends in a direction orthogonal to the second direction and partially covers the tool accessory on the upper side of the tool accessory; and a cover side portion that extends downward from a radially outward edge portion of the cover upper portion and partially covers the tool accessory in an arcuate shape. The second protruding portions may protrude radially inward at (from, along) the radially inward edge portion of the cover upper portion. According to this configuration, because it is not necessary to make the height of the cover in the second direction larger in order to form the second protruding portions, the thickness of the head portion of the grinder can be made smaller.

In one or more embodiments, the side on which the final output shaft is located and the side on which the electric motor is located in the first direction are defined as the front side and the rear side, respectively. The gear housing may have an opening, which permits communication with (access into) the interior of the gear housing, rearward of the bearing box. The grinder may further comprise a sealing member that closes off (covers) the opening. In the state in which the cover is mounted, the cover may abut on the sealing member in the up-down direction. In known grinders of this type, the gear housing sometimes has an opening necessary for manufacturing purposes (e.g., to assembly components within the gear housing). However, according to the above-mentioned configuration, because the cover abuts on the sealing member in the up-down direction, a dust-proof sealing member that closes off the opening (to prevent ingress of dust, etc. into the interior of the gear housing) can be used also to stop (minimize, attenuate) rattling of the cover. In other words, rattling of the cover in the up-down direction can be curtailed without having to provide a (i.e. an additional) dedicated rattling-stopping component.

In one or more embodiments, the sealing member may abut on the cover at least at (along) a rear-side edge portion of the sealing member. Because rattling (oscillation) of the cover in the up-down direction becomes larger the further outward in the radial direction of the cover, rattling of the cover in the up-down direction can be effectively curtailed according to this configuration.

In one or more embodiments, the sealing member need not abut on the cover at (along) the front-side edge portion of the sealing member. According to this configuration, when the cover is rotated relative to the bearing box to attach or detach the cover, the cover will not catch on the front-side edge portion of the sealing member and flip up the sealing member. Accordingly, a decrease in sealing performance can be prevented.

In one or more embodiments, the sealing member may comprise projections that project downward on (from) both edge portions of the sealing member in a direction orthogonal to the up-down direction and the front-rear direction (i.e. in a left-right direction). The projections may be disposed adjacent to the opening. The grinder may further comprise a pressing member that is screw-fastened to the gear housing, abuts on the projections at one or more locations at which the sealing member and the cover do not abut, and presses the sealing member toward the gear housing. According to this configuration, because both edge portions of the sealing member adjacent to the opening are pressed toward the gear housing, the sealing performance at the opening can be increased. Moreover, because the projections of the sealing member abut on the pressing member, the pressing force of the pressing member is concentrated upon the projections, and thus the sealing performance can be increased.

In a fifth aspect of the present teachings, a grinder may comprise: an electric motor having a motor shaft that extends in a first direction; a final output shaft that extends in a second direction orthogonal to the first direction and on which a tool accessory is mountable; a gear shaft that has a first gear and is coaxially coupled to the motor shaft; a second gear that is operatively coupled to (meshed with) the first gear and configured to transmit the rotational driving force of the motor shaft to the final output shaft; at least two motor shaft bearings that are disposed spaced apart in the first direction and support the motor shaft in a rotatable manner; at least one gear shaft bearing that supports the gear shaft in a rotatable manner; and a gear housing that at least partially houses the gear shaft, the second gear, and the at least one gear shaft bearing and supports the at least one gear shaft bearing. The side on which the final output shaft is located in the first direction and the side on which the electric motor is located in the first direction are defined as the front side and the rear side, respectively. A frontmost bearing—which is the bearing, among the at least two motor shaft bearings and the at least one gear shaft bearing, that is located farthest forward—may have a size equal to or less than the size of the smallest bearing among the remaining bearings.

In previously existing flat-head grinders, the gear shaft is coaxially coupled to the motor shaft and the rotational driving force is transmitted from the motor shaft to the spindle via the gear shaft and the gears meshed with the gear shaft. According to this known configuration, the thickness of the tip side of the gear housing that houses the gear (that is, the thickness of the head portion) can be reduced. However, because the gear shaft is coupled to the motor shaft, the number of bearings increases compared with a grinder that does not have a gear shaft. Because bearings are heat generation sources, the outer-wall temperature of the apparatus is higher in such a flat-head grinder, owing to its structure, than in a grinder that does not have a gear shaft. In particular, the bearing located farthest toward the tip side, among the plurality of bearings that support the motor shaft and the gear shaft, is most affected by heat generation. This is because the wall thickness of the gear housing becomes thin toward the tip thereof and that bearing, among the plurality of bearings, is most susceptible to vibration of the spindle.

On the other hand, according to the above-described grinder of the fifth aspect of the present teachings, because the frontmost bearing has a size equal to or less than the size of the smallest bearing among the remaining bearings—that is, because the amount of heat generated by the frontmost bearing, which has the greatest effect upon the outer-wall temperature of the apparatus, is smaller—the outer-wall temperature of the apparatus during operation of the grinder can be reduced.

In one or more embodiments, the at least one gear shaft bearing may include a front-side bearing and a rear-side bearing disposed spaced apart in the first direction. The rear-side bearing may be larger than the front-side bearing. According to this configuration, because the front-side bearing and the rear-side bearing differ in size, it is not necessary to form the inner diameter of the gear housing, which supports the front-side bearing and the rear-side bearing, from the front-side bearing to the rear-side bearing with a constant precision such that the gear housing can satisfactorily support the bearings. In other words, it is sufficient as long as only the locations that support the front-side bearing and the rear-side bearing are formed with the precision necessary to support these bearings. Accordingly, the grinder can be manufactured more easily due to broader manufacturing tolerances.

In one or more embodiments, an inner surface of the gear housing may have a circumferentially-extending groove. The grinder may comprise an O-ring disposed within the circumferentially-extending groove. The frontmost bearing may be supported by the gear housing via the O-ring. According to this configuration, because the size of the frontmost bearing can be made smaller than that of the frontmost bearing of previously existing flat-head grinders, space for the circumferential-direction groove to accommodate the O-ring can be ensured around the frontmost bearing. Accordingly, grease leakage out of the gear housing can be impeded (preferably, prevented) by the O-ring.

In one or more embodiments, the grinder may comprise: a first bearing that supports the final output shaft in a rotatable manner; a second bearing that is located closer to the tool accessory in the second direction than is the first bearing and also supports the final output shaft in a rotatable manner; a bearing box that is fixed to the gear housing and supports (holds) the second bearing; a cover that is configured to be mountable on the bearing box in a detachable manner, partially covers the tool accessory in an arcuate shape along the circumferential direction relative to the final output shaft, and has two or more engaging portions; and a rotation-locking mechanism. The rotation-locking mechanism may comprise: a manipulation member exposed to the exterior of the gear housing; a restricting plate housed within the gear housing; and a pin that passes through the manipulation member and the restricting plate in the third direction (e.g., left-right direction), which is orthogonal to the first direction (e.g., front-rear direction) and the second direction (e.g., up-down direction), and couples the manipulation member and the restricting plate in a manner such that the restricting plate does not come out of the gear housing. The rotation-locking mechanism may be displaceable between: a restricting position, at which the restricting plate and one of the engaging portions engage to thereby restrict (block) rotation of the cover about the final output shaft; and a permitting position, at which the engagement between the restricting plate and the engaging portions is released to thereby permit rotation of the cover about the output shaft. The gear housing may have a pin-release hole, into which the pin is insertable, extending in the third direction at a location adjacent to the manipulation member.

According to this configuration, when removing the rotation-locking mechanism to replace a component, the pin need only be pushed toward the gear housing using a rod or the like to insert the pin into the pin-release hole. Because the coupling between the manipulation member and the restricting plate is released thereby, the rotation-locking mechanism can be easily removed from the gear housing.

In one or more embodiments, the grinder may comprise: a first bearing that supports the final output shaft in a rotatable manner; a second bearing that is located closer to the tool accessory in the second direction than is the first bearing and also supports the final output shaft in a rotatable manner; a bearing box that is fixed to the gear housing and supports (holds) the second bearing; and a bearing retainer that retains the second bearing. The second gear may be mounted around the final output shaft by press-fitting. The side on which the first bearing is located in the second direction and the side on which the second bearing is located in the second direction are defined as the upper side and the lower side, respectively. An outer ring of the second bearing may be sandwiched between the gear housing and the bearing box in the up-down direction, thereby restricting movement in the up-down direction. The second gear may have, on a lower-side edge portion thereof, a ring-shaped recessed portion that extends in the circumferential direction with respect to the final output shaft. The bearing retainer may comprise: a circular-tube (circular cylindrical) portion housed in the ring-shaped recessed portion and mounted on the second gear by press-fitting; and a flange extending radially outward from the lower-side edge portion of the circular-tube portion, with an inner ring of the second bearing being sandwiched between the second gear and the flange in the up-down direction.

According to this configuration, the second gear and the final output shaft are firmly fixed by press-fitting, the bearing retainer and the second gear are firmly fixed by press-fitting, and the inner ring of the second bearing is sandwiched between the second gear and the flange in the up-down direction. Consequently, the positional relationships among the second gear, the final output shaft, and the second bearing in the up-down direction are firmly fixed. Moreover, movement of the outer ring of the second bearing in the up-down direction is restricted as a result of the outer ring being sandwiched between the gear housing and the bearing box in the up-down direction. Consequently, even if the inner flange receives an upward force from the tool accessory when the grinder is being used, the second gear receives the upward force from the inner flange, and thereby movement of the second gear upward relative to the second bearing can be curtailed. As a result, degradation of the meshing of the first gear and the second gear, which would be caused by upward movement of the second gear relative to the second bearing, can be prevented.

In one or more embodiments, the electric motor may have an electric brake function; i.e. a controller of the grinder may be configured to supply currents to the electric motor to electronically brake the electric motor upon receiving a signal that the electric motor should be de-energized (should stop being driven). The grinder may comprise: a first bearing that supports the final output shaft in a rotatable manner; a second bearing that is located closer to the tool accessory in the second direction than is the first bearing and also supports the final output shaft in a rotatable manner; an inner flange located upward of the tool accessory, when the side on which the first through-hole passing through the final output shaft is present and the first bearing is located in the second direction and the side on which the second bearing is located in the second direction are defined as the upper side and the lower side, respectively; a lock nut that has a second through-hole through which the final output shaft passes, is located downward of the tool accessory, and sandwiches the tool accessory between the inner flange and itself in the up-down direction; and a pair of lead washers, the lead washers being disposed around the final output shaft so as to be sandwiched in the up-down direction between the second gear and the inner flange. The lead washers have opposing wedge structures, and are configured to rotate relative to each other to self-lock the rotation of the lock nut when the electric brake function is utilized. The final output shaft may have an outer shape that has two opposing flat surfaces in a cross section orthogonal to the second direction. A radially inward edge portion defining the first through-hole of the inner flange may have a size and shape such that—in a cross section orthogonal to the second direction, when the inner flange rotates from the relative position of the final output shaft and the inner flange by a prescribed angle relative to the final output shaft when the electric motor is being driven—the radially inward edge portion and the final output shaft come into contact, thereby restricting (blocking) further rotation. According to this configuration, if the prescribed angle is set to a degree that permits relative rotation of the pair of lead washers such that a sufficient self-locking function is obtained, then the self-locking function of the pair of lead washers can be ensured in a satisfactory manner.

In one or more embodiments, in a cross section orthogonal to the second direction, the radially inward edge portion of the inner flange may have two opposing flat surfaces at rotational-angle positions substantially corresponding to the two opposing flat surfaces of the final output shaft. According to this configuration, further rotation of the inner flange relative to the final output shaft can be restricted (blocked) by the circumferential-direction edge portions of the two opposing flat surfaces of the final output shaft respectively coming into contact with the two opposing flat surfaces of the radially inward edge portions of the inner flange.

In one or more embodiments, the radially inward edge portion of the inner flange may have two opposing notch portions that are partially notched radially outward such that the two opposing flat surfaces of the final output shaft respectively come into face-to-face contact therewith when the inner flange is rotated to a prescribed angle relative to the final output shaft. According to this configuration, when the inner flange is rotated to (by) a prescribed angle relative to the final output shaft, further rotation of the inner flange relative to the final output shaft can be restricted (blocked) by the two opposing flat surfaces of the final output shaft and the two opposing notch portions of the radially inward edge portion of the inner flange coming into face-to-face contact. Accordingly, compared with a configuration in which the final output shaft and the inner flange come into linear contact with each other, deformation of the final output shaft and/or the inner flange and the occurrence of the final output shaft and the inner flange digging into each other when they come into contact can be curtailed.

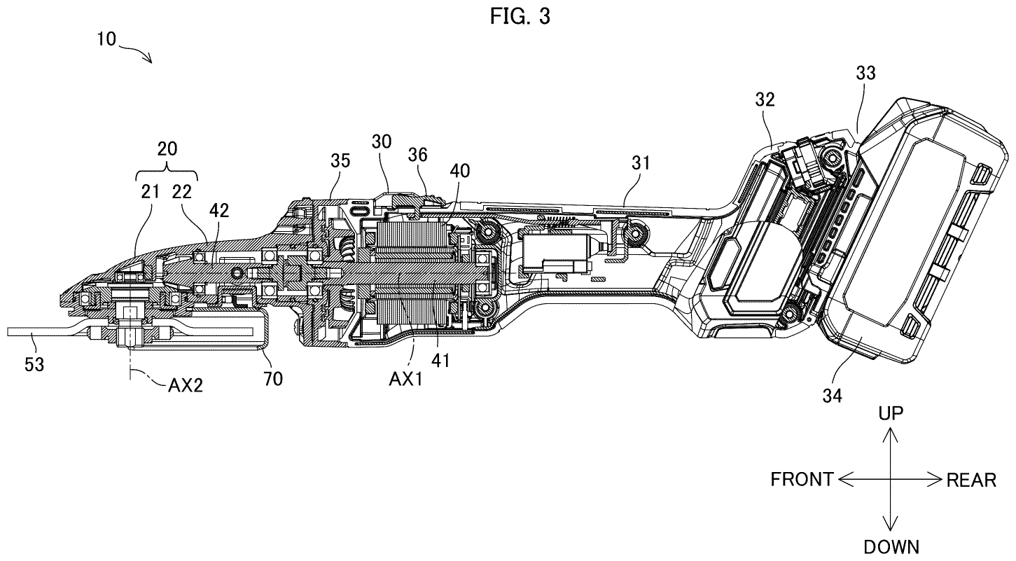

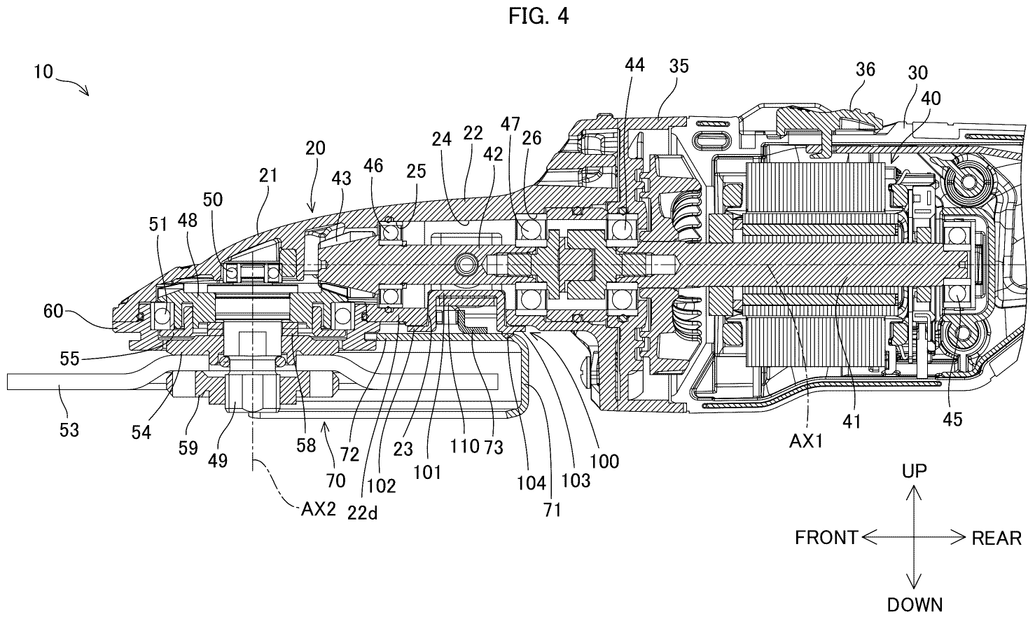

A flat-head grinder 10 (hereinafter simply referred to as grinder 10) according to a representative, non-limiting first embodiment of the present disclosure is described below in more detail with reference to the drawings. As shown in FIG. 3 and FIG. 4, the grinder 10 according to the first embodiment is configured to rotationally drive a substantially disc-shaped tool accessory 53 mounted on a spindle 49. The spindle 49 is rotated by a rotational driving force (rotational energy) provided (output) by an electric motor 40. Grinding wheels, rubber pads, wire brushes, cutting blades, and the like are representative, non-limiting examples of tool accessories (53) that are mountable on the grinder 10 of the present teachings. The user selects an appropriate tool accessory 53 in accordance with the desired processing work and mounts it on the grinder 10. By using the grinder 10, machining work, such as grinding, polishing, and cutting, can be performed on a workpiece according to the type of the tool accessory 53 that was selected.

In the following description, the direction in which a motor shaft 41 of the electric motor 40 extends (in other words, rotational axis AX1 of the electric motor 40) is defined as the front-rear direction of the grinder 10. In the front-rear direction, the side on which the tool accessory 53 is located is defined as the front side, and the opposite side is defined as the rear side. In addition, the direction in which rotational axis AX2 of the spindle 49 extends (in other words, the rotational axis of the tool accessory 53) is defined as the up-down direction of the grinder 10. In the up-down direction, the side on which the tool accessory 53 is located is defined as the lower side, and the opposite side is defined as the upper side. In addition, the direction orthogonal to the up-down direction and the front-rear direction is defined as the left-right direction of the grinder 10. In the left-right direction, the right side when the front side is viewed from the rear side is defined as the right side of the grinder 10, and the opposite side is defined as the left side of the grinder 10.

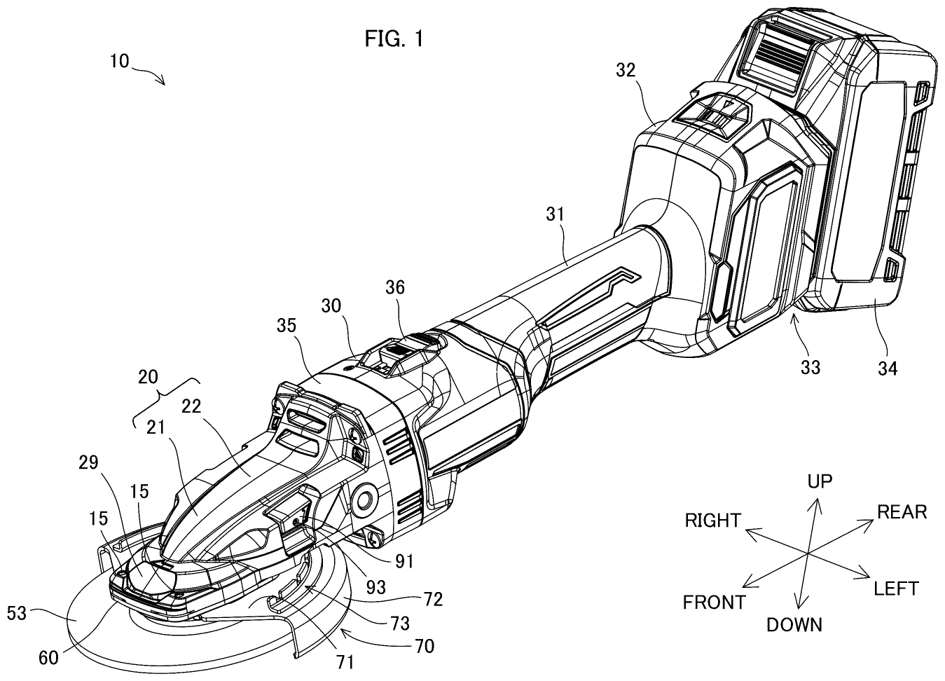

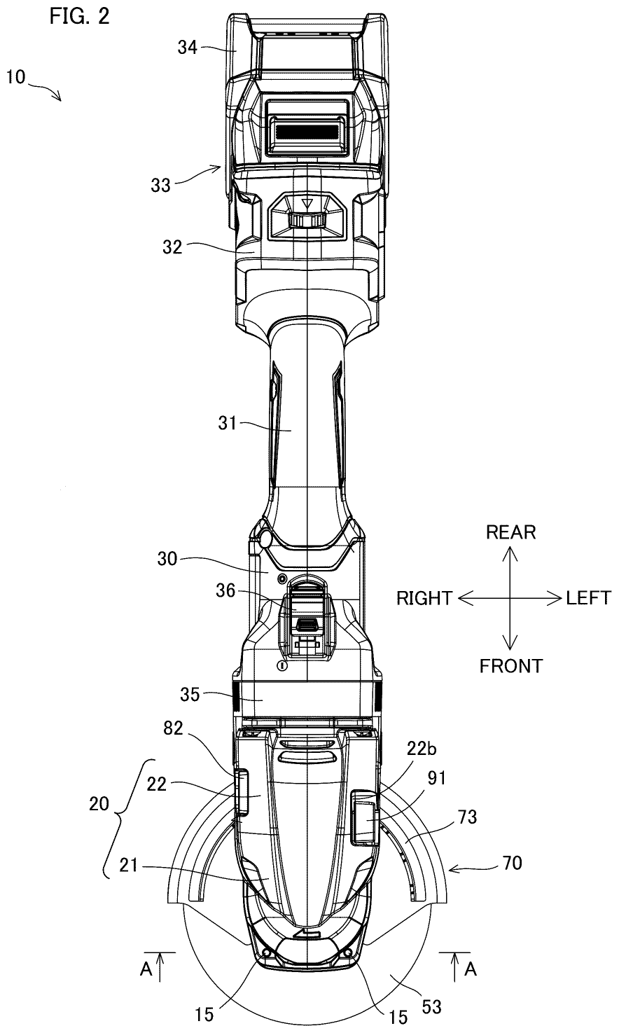

As shown in FIG. 1 and FIG. 2, the grinder 10 comprises a gear housing 20, a motor housing 30, a handle housing 31, and a rear-portion housing 32. The gear housing 20, the motor housing 30, the handle housing 31, and the rear-portion housing 32 are disposed (arranged) in this order as viewed from the front side.

A mechanical mechanism for transmitting the rotational driving force (energy) of (output by) the electric motor 40 to the tool accessory 53 is housed within the gear housing 20 (details described below). The electric motor 40 is housed within the motor housing 30. In the present embodiment, the electric motor 40 is a brushless motor, although other types of motors may be utilized in other embodiments of the present teachings. A manipulation member (e.g., a slide switch or switch knob) 36 for starting and stopping the electric motor 40 is disposed at a top portion of the motor housing 30. The electric motor 40 has an electric brake function. Specifically, when a user manipulates (slides) the manipulation member 36 to stop the electric motor 40 while the electric motor 40 is being driven (energized), an opposite-phase electric current is caused to flow to the electric motor 40, thereby braking the electric motor 40. The supply of electric power to the electric motor 40 is then stopped after a prescribed length of time has elapsed or after the electric motor 40 has rotated to a prescribed rotational angle. Thereby, rotation of the electric motor 40, and, in turn, the tool accessory 53, can be stopped quickly.

The handle housing 31 is a portion designed to be grasped by the user's hand and has an elongated, approximately circular-tube shape that extends in the front-rear direction. A battery-mounting portion 33, on which a battery 34 is mountable in a detachable manner, is located at a rear-edge portion of the rear-portion housing 32. The battery-mounting portion 33 is configured to be mechanically and electrically connectable to the battery 34. The electric motor 40 is configured to be driven by (using) electric power from the battery 34. In other embodiments of the present teachings, AC electric power supplied from a commercial power supply may be used instead of the battery 34. In such an embodiment, a power cord is provided to electrically connect the motor 40 of the grinder 10 to the commercial power supply.

As shown in FIG. 4, the motor shaft 41 is supported in a rotatable manner by two bearings 44, 45, which are spaced apart in the front-rear direction. The bearing 44 is supported by (held in) a gear housing cover 35, which is disposed between the gear housing 20 and the motor housing 30, and rotatably supports the front end of the motor shaft 41. The bearing 45 is supported by (held in) a rear-edge portion of the motor housing 30 and rotatably supports the rear end of the motor shaft 41. The bearings 44, 45 are ball bearings in the present embodiment, but may instead be, e.g., needle bearings or another suitable type of roller element bearings. In the present embodiment, the bearings 44, 45 have different sizes (in other words, different outer diameters). Specifically, the bearing 44 is larger (has a larger outer diameter) than the bearing 45. However, the bearing 44 may be smaller (may have a smaller outer diameter) than the bearing 45, or the sizes of the bearings 44, 45 may be the same.

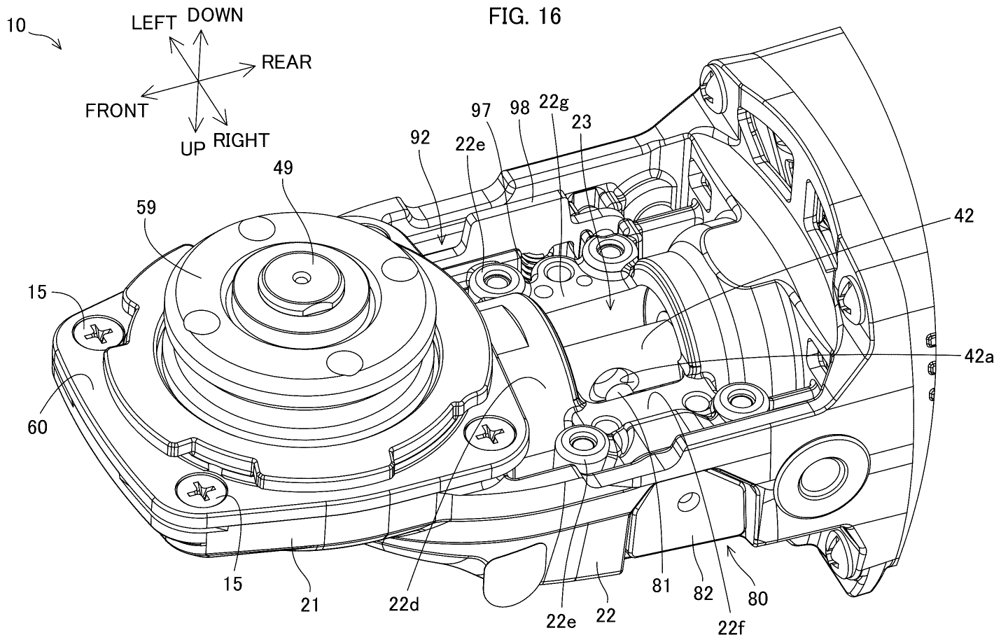

As shown in FIG. 4, a gear shaft 42 is coaxially coupled to the motor shaft 41. The gear shaft 42 is housed within a gear-shaft-housing portion 22, which is a rear-side portion of the gear housing 20. The gear-shaft-housing portion 22 has a tubular shape that is closed in the circumferential direction of rotational axis AX1, except for an opening 23, which will be described below with reference to FIG. 16. The gear shaft 42 is located on the front side of the motor shaft 41. A small bevel gear 43 is formed on a front-end portion of the gear shaft 42. The gear shaft 42 is supported in a rotatable manner by two bearings 46, 47, which are spaced apart in the front-rear direction. The bearing 46 rotatably supports the front end of the gear shaft 42, and the bearing 47 rotatably supports the rear end of the gear shaft 42. The bearings 46, 47 are ball bearings in the present embodiment, but may instead be needle bearings or another suitable type of roller element bearings. In the present embodiment, the size of the bearing 46 is smaller (has a smaller outer diameter) than the size of the bearing 45. In addition, the bearing 47 preferably has the same size as the bearing 44. In other words, the bearing 46, which is located furthest toward the front side, is the smallest of the bearings 44-47. However, the bearings 46, 47 may have the same size. In such an embodiment, the bearings 46, 47 may be smaller in size (have a smaller outer diameter) than the bearings 44, 45.

As shown in FIG. 4, the bearings 46, 47 are supported (held) on a circular-tube-shaped inner surface 24 of the gear-shaft-housing portion 22. Specifically, the bearing 46 is supported (held) by a front-side support region 25 of the inner surface 24, and the bearing 47 is supported (held) by a rear-side support region 26 of the inner surface 24. Owing to the difference in the sizes of the bearings 46, 47, the inner diameter of the rear-side support region 26 is greater than the inner diameter of the front-side support region 25. According to this configuration, because the bearing 46 and the bearing 47 differ in size (in other words, because the bearing 46, which is inserted into the inner surface 24 first when the flat-head grinder 10 is being manufactured, is smaller than the bearing 47, which is inserted afterwards), the bearing 46 and the bearing 47 can be satisfactorily supported even if only the front-side support region 25 and the rear-side support region 26, which respectively support the bearing 46 and the bearing 47, are manufactured with high precision. In other words, as opposed to an embodiment in which the bearing 46 and the bearing 47 are the same size, it is not necessary to accurately (precisely) form all the regions of the inner surface 24, from the front-side support region 25 to the rear-side support region 26, with the same inner diameter. Accordingly, the grinder 10 can be manufactured more easily than embodiments in which smaller manufacturing tolerances are required.

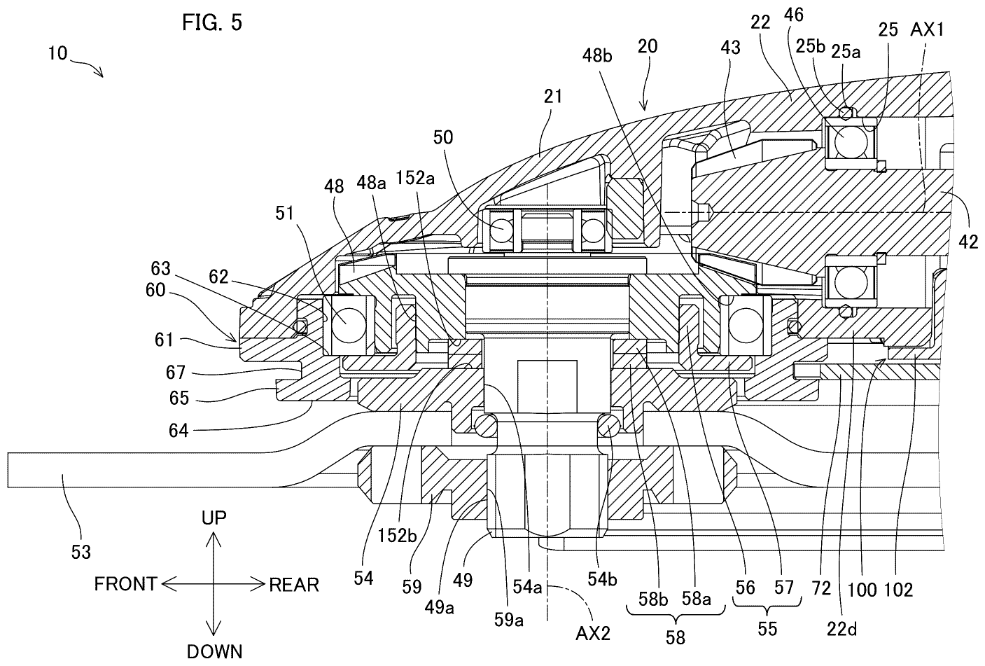

As shown in FIG. 5, a large bevel gear 48, a first bearing 50, a second bearing 51, and an upper-side portion of the spindle 49 are housed within a spindle-housing portion 21 of the gear housing 20. The rotational driving force (energy) of (output by) the motor shaft 41 is transmitted to the spindle 49 via the gear shaft 42 and the large bevel gear 48. Specifically, the large bevel gear 48 meshes with the small bevel gear 43 on the gear shaft 42, and is thereby operatively coupled with the small bevel gear 43. The large bevel gear 48 is firmly fixed to the spindle 49 by being press-fitted around the spindle 49 at the upper-side portion of the spindle 49. The spindle 49 is supported by the first bearing 50 and the second bearing 51, which are disposed spaced apart in the up-down direction, so as to be rotatable about rotational axis AX2. Specifically, the first bearing 50 directly supports the upper end of the spindle 49. The second bearing 51 is located below the first bearing 50. The second bearing 51 supports the radial outer-edge portion of the large bevel gear 48 so as to be rotatable about rotational axis AX2 and supports the spindle 49 via the large bevel gear 48. Rotational axis AX2 is orthogonal to rotational axis AX1. A lower-side portion of the spindle 49 extends from (out of) the spindle-housing portion 21.

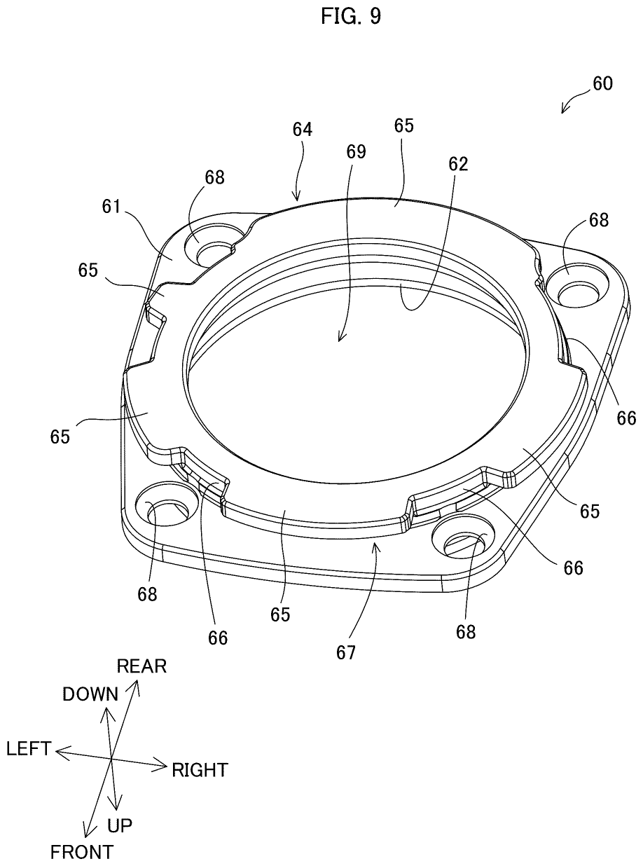

As shown in FIG. 5, the lower-side edge portion of the spindle-housing portion 21 is open. A bearing box 60 is mounted on (in) the lower-side edge portion of the spindle-housing portion 21. As shown in FIG. 9, the bearing box 60 has, in its center, a through-hole 69 for inserting the spindle 49. The through-hole 69 extends in the up-down direction. As shown in FIG. 4, the wall thickness of an upper-side portion of the spindle-housing portion 21 is less than the wall thickness of an upper-side portion of the gear-shaft-housing portion 22.

As shown in FIG. 5 and FIG. 9, the bearing box 60 comprises a base 61 and a cover mounting portion 64. The base 61 has a flat, plate-shaped portion and a portion that protrudes in a circular-tube shape from the flat, plate-shaped portion toward the upper side. The base 61 has a circular-tube-shaped (circular cylindrical) inner surface 62. As shown in FIG. 5, a step portion 63, which protrudes radially inward from the inner surface 62, is formed in (at) a lower portion of the base 61. The step portion 63 extends in a ring shape along a circumferential direction with respect to rotational axis AX2. As shown in FIG. 5, the second bearing 51 is disposed so as to mate with the inner surface 62 of the base 61. Movement of the second bearing 51 in the horizontal direction is thereby restricted by the bearing box 60. In addition, the second bearing 51 is disposed so that an outer ring thereof is sandwiched in the up-down direction between an inner surface of the spindle-housing portion 21 and the step portion 63 of the base 61. Movement of the second bearing 51 in the up-down direction is thereby restricted by the cooperation of the bearing box 60 and the spindle-housing portion 21. The structure and function of the cover mounting portion 64 will be described in further detail below.

As shown in FIG. 5, the second bearing 51 is also retained by a bearing retainer 55. Specifically, the bearing retainer 55 comprises a circular-tube portion 56 and a flange 57. The circular-tube portion 56 is a circular-tube-shaped (circular cylindrical) portion that extends in the up-down direction. The flange 57 extends in a ring shape radially outward from a lower-side edge portion of the circular-tube portion 56. The large bevel gear 48 has a ring-shaped recessed portion (annular recess, slot or groove) 48a in the lower-side edge portion thereof. The ring-shaped recessed portion 48a extends in the circumferential direction with respect to rotational axis AX2. The bearing retainer 55 is fixed to the large bevel gear 48 in the state in which the circular-tube portion 56 is housed within the ring-shaped recessed portion 48a. Specifically, the bearing retainer 55 is firmly fixed to the large bevel gear 48 by press-fitting the circular-tube portion 56 onto the side surface of the ring-shaped recessed portion 48a. An inner ring of the second bearing 51 is sandwiched in the up-down direction between a step portion 48b, which is formed at an upper-side portion of the large bevel gear 48, and the flange 57. Because the flange 57 extends radially outward from the inner ring of the second bearing 51, ingress of dust through the gap between the inner ring of the second bearing 51 and the flange 57 into the interior is prevented (blocked).

As described above, the spindle 49 and the large bevel gear 48 are firmly fixed together by press fitting, and the large bevel gear 48 and the bearing retainer 55 are firmly fixed together by press fitting. Moreover, because the second bearing 51 is fixed in the up-down direction by being sandwiched between the large bevel gear 48 and the bearing retainer 55, the positional relationships among the spindle 49, the second bearing 51, and the large bevel gear 48 in the up-down direction are also firmly fixed. Furthermore, the outer ring of the second bearing 51 is sandwiched in the up-down direction between the inner surface of the spindle-housing portion 21 and the step portion 63 of the bearing box 60. Movement of the second bearing 51 in the up-down direction is thereby restricted. Consequently, even if an inner flange 54 (described below) receives an upward force from the tool accessory 53 when the grinder 10 is being used, the large bevel gear 48 receives the upward force from the inner flange 54, and the large bevel gear 48 is impeded from moving upward relative to the second bearing 51. As a result, even if the inner flange 54 is upwardly impacted, meshing of the small bevel gear 43 and the large bevel gear 48 is not affected.

The tool accessory 53 is mounted on the spindle 49 by (between) the inner flange 54 and a lock nut 59. Specifically, as shown in FIG. 5, the inner flange 54 is disposed on the lower side of (below) the bearing retainer 55. The inner flange 54 has a first through-hole 54a, through which the spindle 49 passes. On the lower side of the inner flange 54, an O-ring 54b is mounted around the spindle 49. The inner flange 54 is prevented from coming off of the spindle 49 by the engagement of the O-ring 54b with the inner flange 54.

As shown in FIG. 5, the lock nut 59 is disposed downward of the inner flange 54. Specifically, the lock nut 59 has a second through-hole 59a, through which the spindle 49 passes. A male-thread portion 49a is formed on the lower end of the spindle 49. In addition, a female thread, which threadedly engages with the male-thread portion 49a, is formed on the inner surface of the lock nut 59, which defines the second through-hole 59a. By disposing the tool accessory 53 between the inner flange 54 and the lock nut 59 and tightening the lock nut 59, the tool accessory 53 is sandwiched (secured) in the up-down direction between the inner flange 54 and the lock nut 59, and the position of the tool accessory 53 relative to the spindle 49 is thereby fixed.

According to the grinder 10 described above, when the user manipulates the manipulation member 36 to cause the electric motor 40 to be driven (energized), the rotational energy of the motor shaft 41 is transmitted to the spindle 49 via the gear shaft 42 and the large bevel gear 48, whereby the gear train causes the spindle 49 to rotate at a lower rotational speed than the motor shaft 41, but with greater torque. At this time, the direction of the rotational motion is also converted from a direction around rotational axis AX1 to a direction around rotational axis AX2. Owing this bevel gear mechanism, as the motor shaft 41 rotates, the spindle 49 is rotated around rotational axis AX2, resulting in the tool accessory 53, which is fixed by the inner flange 54 and the lock nut 59, being rotated along with the spindle 49.

As shown in FIG. 1, a cover 70 is mounted in a detachable manner on the bearing box 60 (the mounting method will be described below). The cover 70 partially covers the tool accessory 53 in an arcuate shape along the circumferential direction relative to rotational axis AX2.

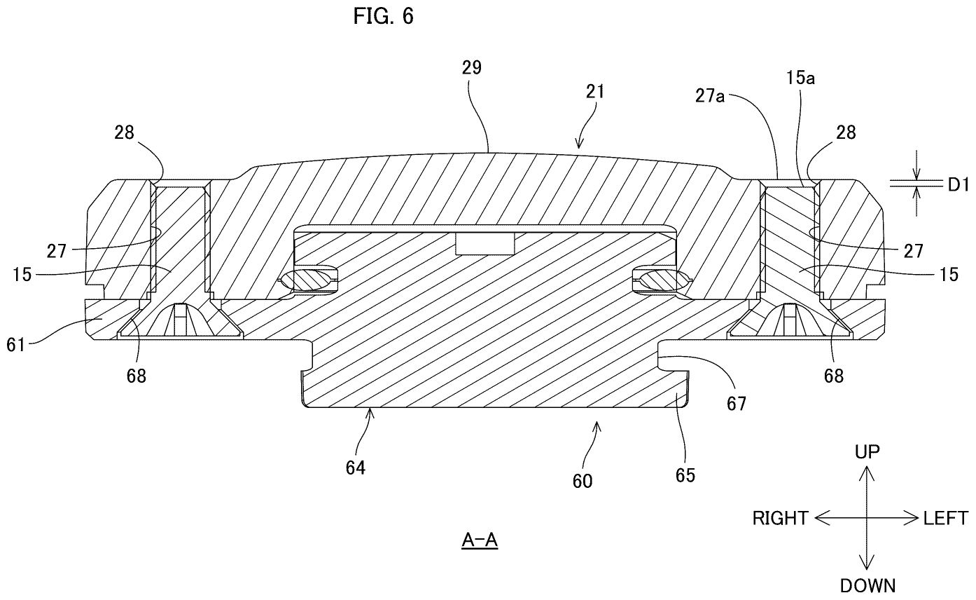

The bearing box 60 described above is fixed to the spindle-housing portion 21 in the following manner. As shown in FIG. 6, the spindle-housing portion 21 has two first through-holes 27, which pass through the spindle-housing portion 21 in the up-down direction and which are disposed forward of the spindle 49 in the front-rear direction. Female threads are formed on the inner surfaces of the spindle-housing portion 21 that define the first through-holes 27. The two first through-holes 27 are respectively located in the vicinities of the two end portions of the spindle-housing portion 21 in the left-right direction. In addition, the two first through-holes 27 are located in the vicinity of the front-side edge portion of the spindle-housing portion 21. It is noted that, although not shown in the drawings, the spindle-housing portion 21 also has two through-holes similar to the first through-holes 27 rearward of the spindle 49.

As shown in FIG. 6 and FIG. 9, the bearing box 60 has four second through-holes 68, which pass through the base 61 of the bearing box 60 in the up-down direction (in FIG. 6, only two of the second through-holes 68 are shown). As shown in FIG. 9, the four second through-holes 68 are located in (at) the four corners—front, rear, left, and right—of the base 61. Female threads are not formed on the inner surfaces of the base 61 that define the second through-holes 68. Furthermore, the second through-holes 68 have shapes that conform to the head portions of screws 15 (described below); i.e. the second through-holes 68 each have a countersunk (conical) shape, so that the outer surface of the head portions of the screws 15 will be flush with, or submerged relative to, the surrounding surfaces of the bearing box 60. The four second through-holes 68 are respectively coaxial with the four first through-holes 27 in the spindle-housing portion 21 described above.

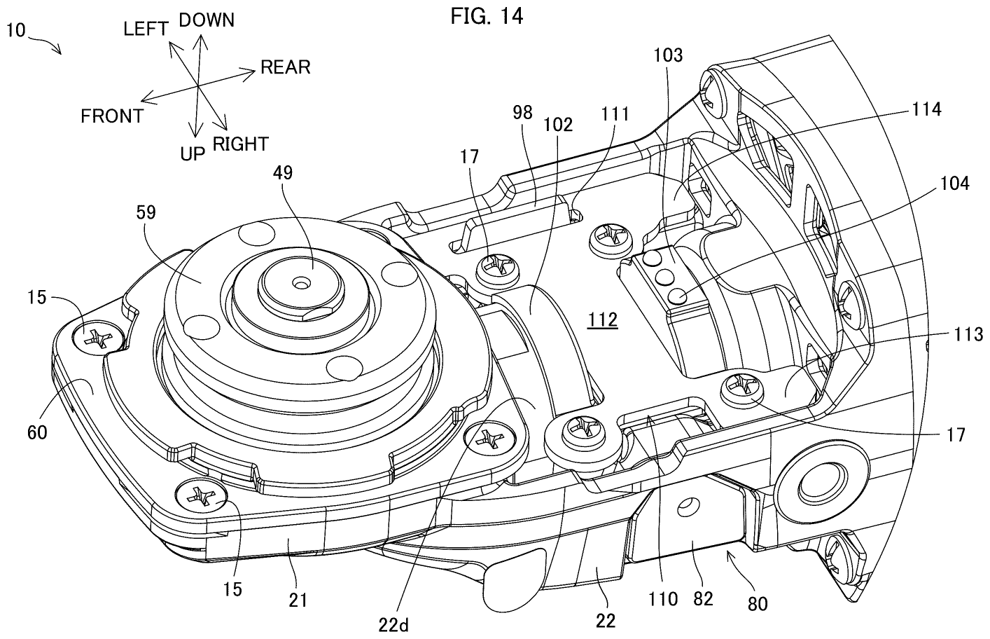

As shown in FIG. 1 and FIG. 6, the bearing box 60 is fixed to the spindle-housing portion 21 by inserting the screws 15, which threadedly engage with the female threads on the inner surfaces that define the first through-holes 27, in the direction from the lower side to the upper side and by tightening the screws 15. As shown in FIG. 14, the screws 15 are similarly inserted into the two through-holes in the spindle-housing portion 21, which are located rearward of the spindle 49, and tightened.

According to the configuration described above, the first through-holes 27 are in the form of through-holes that pass through the spindle-housing portion 21 in the up-down direction. Consequently, when forming the first through-holes 27 in the spindle-housing portion 21 using a tap drill during the manufacture of the grinder 10, the first through-holes 27 can be formed so that incomplete thread portions are not present at upper-end portions of the first through-holes 27. Accordingly, the thickness of the spindle-housing portion 21 at the locations of the first through-holes 27 can be reduced by (i) the length of such (omitted) incomplete thread portions in the up-down direction and (plus) (ii) a thickness corresponding to the wall thickness of an omitted spindle-housing portion that would close off the screw holes, compared with previously existing grinders, in which screw holes corresponding to the first through-holes 27 are blind screw holes (i.e., screw holes in which the upper sides are closed). As a result, because the head (front) portion of the grinder 10 can be made thinner than previously existing grinders, it becomes easier to insert the head (front) portion into narrow locations where the height (space) is constrained (limited) when machining such locations, thereby improving convenience for the user and increasing the types of locations that can be effectively machined using the grinder 10. The head portion is the front-end portion of the spindle-housing portion 21 and is the portion that needs to be inserted into narrow locations where the height is constrained when machining such locations.

Typically, if the screw holes corresponding to the first through-holes 27 were to be designed as blind screw holes (i.e., similar to previously existing grinders), then the length of incomplete thread portions would be approximately 4 mm, and the wall thickness of the spindle-housing portion, which closes off the screw holes, would be approximately 2 mm. Consequently, because the above-described configuration has the first through-holes 27 (i.e. open holes), the thickness of the head portion can be reduced by approximately 6 mm compared with previously existing grinders.

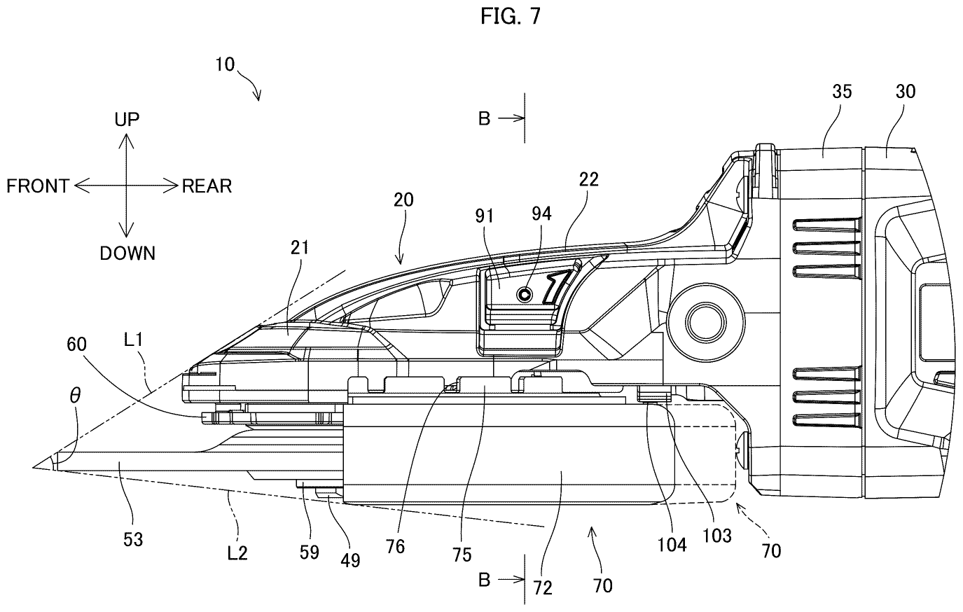

The ease of inserting the head portion into narrow locations where height is constrained can also be evaluated in terms of access angle θ. Access angle θ is the angle formed by first straight line L1 and second straight line L2 shown in FIG. 7. First straight line L1 is a straight line that, as viewed in the left-right direction, extends rearward and upward from the front-upper edge of the tool accessory 53 and is tangent to the spindle-housing portion 21 (i.e. first straight line L follows the outer contour of the upper side of the spindle-housing portion 21). Second straight line L2 is a straight line that, as viewed in the left-right direction, extends rearward and downward from the front-lower edge of the tool accessory 53 and is tangent to a component of the grinder 10 (i.e. second straight line L2 intersects a lowermost component at the front portion of the grinder 10). In the present embodiment, the component defining second straight line L2 is the lower, front edge of the cover 70, as shown in FIG. 7. However, the component defining second straight line L2 may vary depending on the configuration of the grinder 10.

If there are multiple straight lines tangent to the spindle-housing portion 21 at multiple locations, then “straight line tangent to the spindle-housing portion 21” refers to the straight line that first contacts the spindle-housing portion 21 when a straight line extending upward in the up-down direction from the front-upper edge of the tool accessory 53 is gradually tilted (pivoted) rearward with the front-upper edge of the tool accessory 53 as the pivot point. Similarly, if there are multiple straight lines tangent to components at multiple locations, then “straight line tangent to a component of the grinder 10” refers to the straight line that first contacts the component of the grinder 10 when a straight line extending downward in the up-down direction from the front-lower edge of the tool accessory 53 is gradually tilted (pivoted) rearward with the front-lower edge of the tool accessory 53 as the pivot point.

According to a configuration having the first through-holes 27 described above, access angle θ can be made to be less than 42° in contrast to previously existing grinders that have an access angle θ of 42° or greater. Access angle θ may be 40° or less. In the present embodiment, access angle θ is 39°.

In the present embodiment, as shown in FIG. 6, the screws 15 are disposed within the first through-holes 27 such that tips 15a thereof are located at a depth of distance D1 from upper-side edge portions 27a of the first through-holes 27. According to this configuration, the tips 15a of the screws 15 do not project upward from (out of) the spindle-housing portion 21. Consequently, this design prevents the tips 15a of the screws 15 from getting caught on a user's fingers or a workpiece. If distance D1 is set to a value greater than 0 mm and less than 1 mm, then such an effect can be obtained while reducing the thickness of the head portion as much as possible. Dimensional tolerances may be taken into account in determining distance D1 so that the tips 15a of the screws 15 do not project upward of (beyond) the upper-side edge portions 27a of the first through-holes 27.

In the present embodiment, as shown in FIG. 6, the upper-side edge portions 27a of the first through-holes 27 are also formed with countersunk portions 28, which are countersunk so as to increase in diameter in the upward direction. During the manufacture of the grinder 10, the first through-holes 27 may be formed using a tap drill after the gear housing 20 has been coated. In a configuration having the countersunk portions 28, if the gear housing 20 having the countersunk portions 28 around the locations where the first through-holes 27 are formed is made with a die, the gear housing 20 is subsequently coated, and thereafter the first through-holes 27 are formed using a tap drill, then the coating on the upper-side edge portions 27a is not likely to peel off when the first through-holes 27 are being formed.

In the present embodiment, as shown in FIG. 6, the two upper-side edge portions 27a are located downward, in the up-down direction, of a center portion 29 of the outer surface of the spindle-housing portion 21 between the two first through-holes 27 as viewed in a cross section through the two axes of the two screws 15 located forward of the spindle 49 (i.e., the cross section shown in FIG. 6). In this configuration, the height of the spindle-housing portion 21 in the head portion is lower at the two end portions thereof in the left-right direction than at the center portion 29 thereof. Consequently, when the grinder 10 is being used by inserting the head portion into a narrow location where height is constrained (space is limited), the head portion can be prevented from getting caught on surrounding obstacles even if machining work is performed while the head portion is being pivoted to the left and right (in other words, about rotational axis AX2).

Furthermore, in the above-described grinder 10, because the gear shaft 42 is provided, the number of bearings that are heat generation sources becomes greater than in a grinder that does not comprise the gear shaft 42; as a result, the outer-wall temperature may become higher than in a grinder having fewer bearings in the gear housing. In particular, among the bearings 44-47, the bearing 46, which is located along the motive-power-transmission pathway closest to the spindle 49, is most susceptible to the effects of spindle vibration; as a result, the outer-wall temperature around the bearing 46 tends to be higher. However, in the present embodiment, because the bearing 46 is the smallest of the bearings 44-47, it generates less heat, thereby making it possible to reduce the outer-wall temperature.

In addition, because the size of the bearing 46 is the smallest among the bearings 44-47, sufficient space for forming a circumferential-direction groove 25a for disposing an O-ring 25b in the front-side support region 25 of the inner surface 24 of the gear-shaft-housing portion 22 can be ensured, as shown in FIG. 5. The bearing 46 is thereby supported by the gear-shaft-housing portion 22 via the O-ring 25b. According to this configuration, leakage of bearing grease out of the motor housing 30 into the gear housing 20 can be impeded or blocked (preferably, prevented) by the O-ring 25b.

In alternative embodiments of the first embodiment, the number of bearings supporting the motor shaft 41 may be three or more. Alternatively or additionally, the number of bearings supporting the gear shaft 42 may be one or may be three or more. In these alternative embodiments as well, the outer-wall temperature can be reduced and sufficient space for forming the circumferential-direction groove 25a can be secured, as in the present embodiment, as long as the bearing located most forward among the bearings supporting the motor shaft 41 and the bearings supporting the gear shaft 42 has a size equal to or less than the size of the smallest bearing among the remaining bearings.

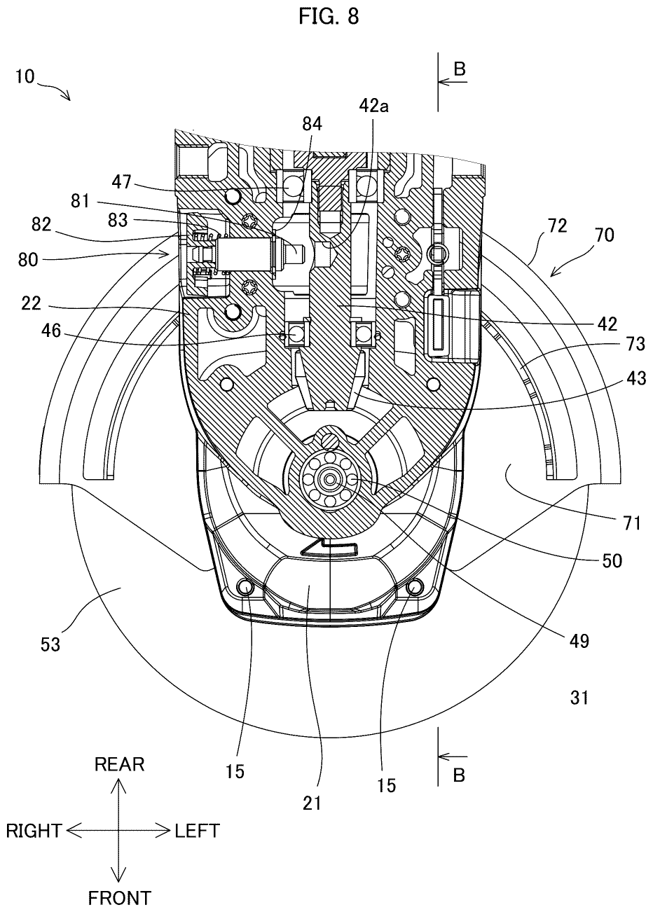

As shown in FIG. 8, the grinder 10 further comprises a shaft-locking mechanism 80. The shaft-locking mechanism 80 is designed to restrict (block) the rotation of the spindle 49 by restricting (blocking) the rotation of the gear shaft 42 when mounting or removing the tool accessory 53. By restricting (blocking) the rotation of the gear shaft 42, concomitant rotation of the spindle 49 when the lock nut 59 is rotated can be prevented.

As shown in FIG. 8, the shaft-locking mechanism 80 comprises a pin 81, a manipulation member (e.g., a button or knob) 82, a biasing spring 83, and a stop ring 84. The pin 81 extends in the left-right direction so as to pass through a right-side surface of the gear-shaft-housing portion 22. The stop ring 84 is mounted in the vicinity of the tip (left end) of the pin 81. When the stop ring 84 abuts against the inner surface 24 of the gear-shaft-housing portion 22, the pin 81 is housed within the gear-shaft-housing portion 22 in a state such that the pin 81 is movable in the left-right direction without being removable from the gear-shaft-housing portion 22. The manipulation member 82 is coupled to the base end (right end) of the pin 81. As shown in FIG. 2 and FIG. 14, an outer surface of the manipulation member 82 is exposed to the exterior of the gear-shaft-housing portion 22 so that a user can manually depress it, as will be further explained below.

The biasing spring 83 is disposed in a compressed state between the manipulation member 82 and an outer surface of the gear-shaft-housing portion 22. The biasing spring 83 continuously biases the manipulation member 82 rightward, i.e. away from engagement of the pin 81 in the gear shaft 42. Consequently, the pin 81 coupled to the manipulation member 82 is also biased rightward along with the manipulation member 82, whereby the pin 81 is normally kept (held) in a position such that the stop ring 84 abuts on the inner surface 24 of the gear-shaft-housing portion 22 (the position shown in FIG. 8).

As shown in FIG. 8, the gear shaft 42 has an insertion opening 42a. The insertion opening 42a is formed as a blind hole (depression, recess) and is located at a position corresponding to the pin 81 in the front-rear direction. The insertion opening 42a has a shape and size that conforms to the tip (left end) of the pin 81. When the user presses the manipulation member 82 leftward, the manipulation member 82 and the pin 81 move leftward against the biasing force of the biasing spring 83 until the tip of the pin 81 abuts on the gear shaft 42. Then, when, in this state, the user manually turns the spindle 49 (e.g., by grasping and manually rotating the lock nut 59), the insertion opening 42a eventually rotates to a position opposing the pin 81 (the position shown in FIG. 8), where the tip of the pin 81 will enter (insert) into the insertion opening 42a of the gear shaft 42. Rotation of the gear shaft 42 is thereby restricted (blocked), in turn restricting (blocking) further rotation of the spindle 49. By further turning the lock nut 59 while continuing to press the manipulation member 82 in this state, the user can mount or remove the tool accessory 53 while the spindle 49 remains stationary. When the user thereafter releases pressure on the manipulation member 82, the pin 81 and the manipulation member 82 are returned to the position shown in FIG. 8 by the biasing force of the biasing spring 83, such that the gear shaft 42 (and thus the spindle 49 and tool accessory 53) may freely rotate again.

Next, a configuration for mounting and removing the cover 70 will be described. As shown in FIG. 9, the bearing box 60 has the cover mounting portion 64 on the lower side of the base 61, as was described above. The cover mounting portion 64 projects in a ring shape downward from the lower surface of the base 61. The cover mounting portion 64 has a plurality of first protruding portions 65 (in the example shown in FIG. 5, five) that project radially outward at (along) a lower-side edge portion of the cover mounting portion 64. The first protruding portions 65 are spaced apart in the circumferential direction. In addition, the cover mounting portion 64 has first recessed portions 66 (in the example shown in FIG. 5, five) respectively disposed (arranged, interposed) between circumferentially-adjacent ones of the first protruding portions 65.

The plurality of first protruding portions 65 and the plurality of first recessed portions 66 are spaced apart from the base 61 in the up-down direction, and an arc-shaped groove 67 is formed along a portion of the circumference of the bearing box 60 between the plurality of first protruding portions 65 and the base 61, as shown in FIG. 5 and FIG. 9.

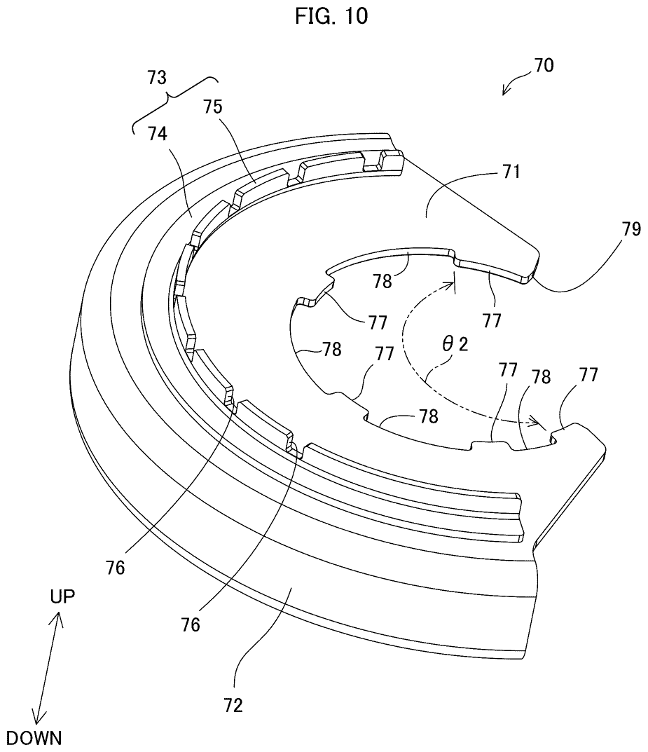

As shown in FIG. 1 and FIG. 10, the cover 70 has a cover upper portion 71 and a cover side portion 72. The cover upper portion 71 is a fan-shaped (segment of circle shape) flat-plate portion that extends in a direction orthogonal to the up-down direction. The central portion of the cover upper portion 71 in the radial direction is notched in a substantially arcuate shape. In addition, a radially inward edge portion of the cover upper portion 71 has an open shape that is partially notched in the circumferential direction. This portion, which is notched in the circumferential direction, will be referred to hereinafter as notch portion 79. As shown in FIG. 1, the cover upper portion 71 partially covers substantially the rear half of the tool accessory 53 on the upper side of the tool accessory 53.

As shown in FIG. 1 and FIG. 10, the cover side portion 72 is a portion that extends downward from an outer-side edge portion of the cover upper portion 71 in the radial direction. As shown in FIG. 1, the cover side portion 72 partially covers substantially the rear half of the tool accessory 53 in an arcuate shape sideward of the tool accessory 53.

As shown in FIG. 10, the cover upper portion 71 has a plurality of second protruding portions 77, which protrude radially inward, on the radially inward edge portion thereof. The second protruding portions 77 (in the example shown in FIG. 10, five) are spaced apart in the circumferential direction. In addition, the cover upper portion 71 has second recessed portions 78 (in the example shown in FIG. 10, four) respectively disposed (arranged, interposed) between circumferentially-adjacent ones of the second protruding portions 77.

When the relative rotational-angle position of the cover 70 with respect to the bearing box 60 is at a prescribed insertion-allowing position, at which the plurality of first protruding portions 65 and the plurality of second recessed portions 78 are located at corresponding rotational-angle positions and the plurality of second protruding portions 77 and the plurality of first recessed portions 66 are located at corresponding angular positions, the second protruding portions 77 are respectively capable of passing through the first recessed portions 66 of the bearing box 60 in the up-down direction. In addition, the first protruding portions 65 are respectively capable of passing through the second recessed portions 78 in the up-down direction. In the present embodiment, the first protruding portions 65 and the second protruding portions 77 are configured so that the insertion-allowing position is uniquely determined (so as to be fixed at a single relative rotational-angle position). Such a configuration is obtained if, for example, at least one of the locations, sizes, and shapes of the second protruding portions 77 is asymmetrical in the circumferential direction and at least one of the locations, sizes, and shapes of the first recessed portions 66 corresponds exactly to the second protruding portions 77.

Such a cover 70 can be mounted on the bearing box 60 in the following manner. First, the user disposes the cover 70 relative to the bearing box 60 at the above-described (unique, sole) insertion-allowing position and brings (moves) the cover 70 toward the bearing box 60, thereby fitting the cover 70 around the cover mounting portion 64 of the bearing box 60 from below until the upper surface of the cover upper portion 71 abuts on the base 61. At this time, the second protruding portions 77 are positioned upward of the first protruding portions 65, and the cover 70 surrounds the bearing box 60 in the circumferential direction (more specifically, the cover upper portion 71 surrounds the portion of the bearing box 60 that is between the base 61 on one side and the first protruding portions 65 and the first recessed portions 66 on the other side). The relative position of the cover 70 with respect to the bearing box 60 at this time will be referred to hereinafter as the insertion position.

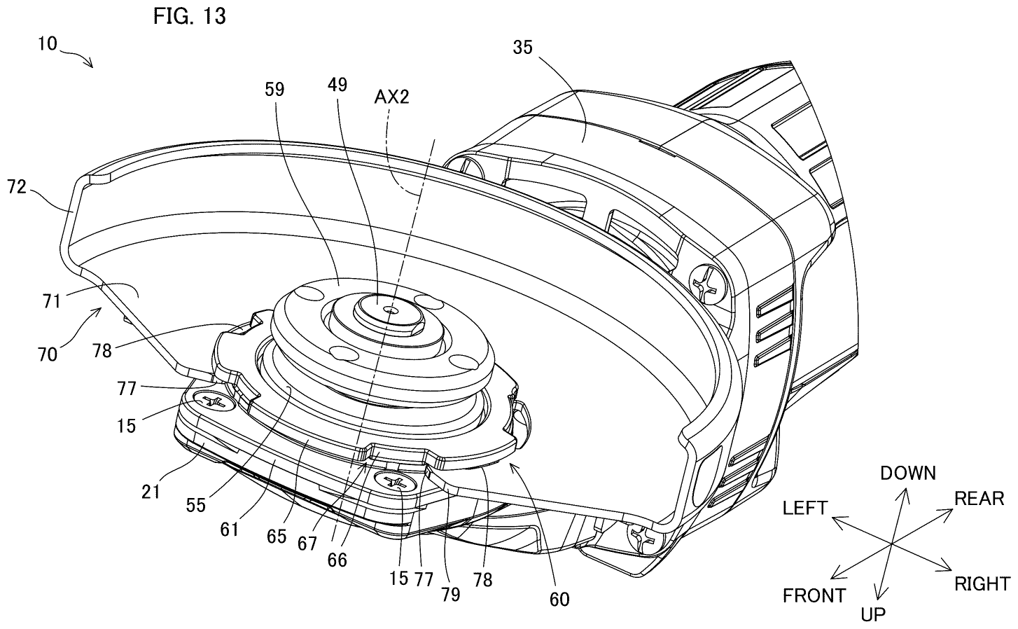

Next, the user rotates the cover 70 relative to the bearing box 60 about rotational axis AX2 from the insertion position to a rotational-angle position at which the first protruding portions 65 and the second protruding portions 77 are aligned with each other. One example of such a rotational-angle position is shown in FIG. 13. In this rotational-angle position, the notch portion 79 faces forward and the center of the cover side portion 72 in the circumferential direction coincides with the center of the grinder 10 in the left-right direction. The rotational-angle position shown in FIG. 13 is the rotational-angle position for a typical usage state of the grinder 10. At this time, as shown in FIG. 13, the second protruding portions 77 of the cover 70 are accommodated within the groove 67 of the bearing box 60, and the first protruding portions 65 and the second protruding portions 77 are engaged in the up-down direction. The cover 70 can thereby be fixed to the bearing box 60 in a state such that the cover 70 will not come off in the up-down direction.

In addition, as described above, the first protruding portions 65 and the second protruding portions 77 are configured so that the insertion-allowing position is uniquely determined. Consequently, when the user rotates the cover 70 from the insertion position to the rotational-angle position at which the first protruding portions 65 and the second protruding portions 77 align with each other, the cover 70 will not unintentionally come off the bearing box 60 in the up-down direction.

As shown in FIG. 7, when the cover 70 is in the mounted state, the cover 70 is located forward of the front-side edge portion of the gear housing cover 35 and the front-side edge portion of the motor housing 30, and at least partially overlaps the lower-side portion of the gear housing cover 35 and the lower-side portion of the motor housing 30 as viewed in the front-rear direction.

In the present embodiment, because the first protruding portions 65 and the second protruding portions 77 are engaged in the up-down direction at five locations along the circumferential direction, the cover 70 can be stably (i.e., with little rattling) retained (held) in the up-down direction. However, the number of first protruding portions 65 may be any number that is at least two or more. The same applies to the number of second protruding portions 77.

Furthermore, as shown in FIG. 10, the two second protruding portions 77, from among the plurality of second protruding portions 77 in the present embodiment, that are spaced farthest apart in the circumferential direction are spaced apart at an angle greater than 180° in the circumferential direction along the radially inward edge portion of the cover 70. In FIG. 10, this separation angle is shown as θ2. According to this configuration, even if the cover 70 is displaced from the side where the notch portion 79 of the cover 70 is located toward the side where the notch portion 79 is not located (i.e., toward the rear side from the mount position in FIG. 13), because the side surfaces of the two second protruding portions 77 that are spaced farthest apart in the circumferential direction engage with the bearing box 60 (more specifically, the side surface defining the groove 67), the cover 70 is prevented from coming off the bearing box 60 in the horizontal direction and movement of the cover 70 in the horizontal direction is restricted.

Furthermore, the grinder 10 has a structure for fixing the rotational-angle position of the cover 70 relative to the bearing box 60 at a suitable position. The following is a description of a representative example of such a configuration. As shown in FIG. 10, the cover 70 comprises a lock plate 73 on the upper surface of the cover upper portion 71. The lock plate 73 has an arcuate shape that conforms to the arcuate shape of the cover side portion 72 as viewed from the upper side. The lock plate 73 is located in the region of the radially outward half of the cover upper portion 71. The lock plate 73 has a mount 74 and a plurality of engaging portions (e.g., tabs, ridges, ribs) 75. The mount 74 is a portion that is (extends) parallel to the cover upper portion 71 and is fixed to the upper surface of the cover upper portion 71 by any suitable, e.g., material bonding, means (for example, welding). The engaging portions 75 extend upward from the radially inward edge portion of the mount 74 and are arrayed along the arcuate shape of the lock plate 73. Engaging grooves 76 are respectively formed between circumferentially-adjacent ones of the engaging portions 75.

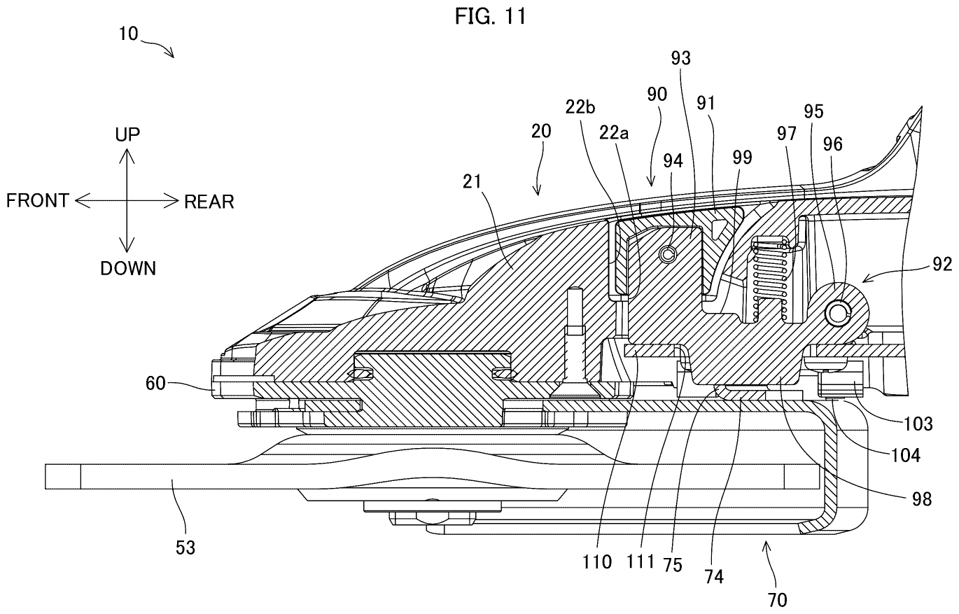

As shown in FIG. 11, the grinder 10 further comprises a rotation-locking mechanism (rotational position fixing mechanism) 90, i.e. a mechanism (e.g., a detent) that releasably fixes the rotational position of the cover 70 relative to the bearing box 60. The rotation-locking mechanism 90 comprises a manipulation member (e.g., lever, knob, finger grip) 91 and a restricting plate (blocking plate or locking plate) 92. As shown in FIG. 2 and FIG. 11, the manipulation member 91 is disposed within a recessed portion 22b, which is formed in the upper-left edge portion of the gear-shaft-housing portion 22, so as to be exposed by (through) the gear-shaft-housing portion 22. As shown in FIG. 11, a pin 94 is inserted into a coupling portion 93, which is a substantially rectangular portion of the front side and the upper side of the restricting plate 92, and into the manipulation member 91 so as to pass therethrough in the left-right direction. The pin 94 is in the form of a C-shaped elastic pin that couples the restricting plate 92 and the manipulation member 91 in a manner such that they are non-movable relative to each other; i.e. the restricting plate 92 and the manipulation member 91 move integrally. An opening 22a, which passes through the bottom surface of the recessed portion 22b of the gear-shaft-housing portion 22 in the up-down direction, is formed in that bottom surface. The coupling portion 93 is disposed so as to pass through the opening 22a. The restricting plate 92, except for the upper-side portion of the coupling portion 93, is housed within the gear-shaft-housing portion 22. The manipulation member 91 is sized such that it cannot pass through the opening 22a.

As shown in FIG. 11, the restricting plate 92 extends within the gear-shaft-housing portion 22 rearward from the coupling portion 93. The restricting plate 92 comprises a pivot shaft receiving portion 95 at a rear-edge portion thereof. The pivot shaft receiving portion 95 is a ring-shaped portion having a through-hole that extends in the left-right direction. The pivot shaft receiving portion 95 is located rearward of the rear-side edge portion of the opening 22a. A pin (pivot shaft) 96 is inserted into this through-hole. The pin 96 is in the form of a C-shaped elastic pin that is non-movable relative to the pivot shaft receiving portion 95. The left end and right end of the pin 96 are supported in a rotatable manner within respective bosses formed in the interior of the gear-shaft-housing portion 22. According to this configuration, the manipulation member 91 and the restricting plate 92 are pivotable via the pin 96 relative to the gear housing 20 and the cover 70.

Between the manipulation member 91 and the pivot shaft receiving portion 95 in the front-rear direction, as shown in FIG. 11, a biasing member 97 is disposed in a compressed state between the inner surface of the upper side of the gear-shaft-housing portion 22 and the restricting plate 92. The biasing member 97 continuously biases the restricting plate 92 downward. Consequently, the restricting plate 92 is held at a position at which the bottom surface of the coupling portion 93 abuts against a pressing member 110 (the details of which will be described below), the position of which is fixed relative to the gear-shaft-housing portion 22 (see FIG. 11). The position of the manipulation member 91 and the restricting plate 92 at this time (the initial position) will be referred to hereinafter as the restricting position (blocking position, locking position).

As shown in FIG. 11 and FIG. 14, the pressing member 110 has a through-hole 111, which extends in the up-down direction. The restricting plate 92 has a downward-protruding engaging portion 98 at (along) a lower-side edge thereof. The engaging portion 98 is substantially rectangular, the longitudinal (elongated) direction of which is in the front-rear direction. The engaging portion 98 extends through the through-hole 111 of the pressing member 110 and downward of the pressing member 110.

To operate such a rotation-locking mechanism 90, the user pivots the manipulation member 91 and the restricting plate 92 upward via the pin 96 by placing a finger on the lower side of a left-side surface of the manipulation member 91 and pulling rearward. As shown in FIG. 7, an arrow mark that indicates the direction of manipulation of this operation is provided (e.g., affixed) on the manipulation member 91. The engaging portion 98 also will be pivoted upward by this pivoting operation. The manipulation member 91 and the restricting plate 92 are pivotable to a position at which an upper surface 99 of an intermediate portion of the restricting plate 92 in the front-rear direction abuts against a bottom portion of the recessed portion 22b of the gear housing 20. The position of the manipulation member 91 and the restricting plate 92 at this time (the manipulation limit position) will be referred to hereinafter as the permitting position.

When the manipulation member 91 and the restricting plate 92 are in the restricting position (rotational position fixing position), the engaging portion 98 is at a location in the up-down direction at which the tip (lower-side edge portion) thereof can fit (be inserted) into one of the engaging grooves 76 of the cover 70, as shown in FIG. 11. On the other hand, when the manipulation member 91 and the restricting plate 92 are in the permitting position, the engaging portion 98 is at a location in the up-down direction at which the tip (lower-side edge portion) thereof cannot reach (fit) into the engaging grooves 76 of the cover 70 (not shown in the drawings). That is, the lowermost tip of the engaging portion 98 is at a location that is upward of the engaging portions 75 of the cover 70.

In view of this design, the user can mount the cover 70 using the following procedure. First, the user disposes the cover 70 in the insertion position and rotates the cover 70 to a prescribed position while pulling the manipulation member 91 rearward. Next, the user stops pulling on the manipulation member 91. As a result, the engaging portion 98 is urged by the biasing force of the biasing member 97 to return to the engaged position. At this time, if one of the engaging grooves 76 of the cover 70 is directly below the engaging portion 98, then the engaging portion 98 will fit into the engaging groove 76 that is directly below the engaging portion 98. In this state, rotation of the cover 70 is restricted (blocked), because the engaging portion 98 will abut against the side surfaces of the engaging portions 75 located on both sides of the engaging portion 98 if an attempt is made (intentionally or accidentally) to rotate the cover 70 relative to the bearing box 60. On the other hand, if one of the engaging grooves 76 of the cover 70 is not directly below the engaging portion 98, then the engaging portion 98 will abut on the upper surface of one of the engaging portions 75. When the user further rotates the cover 70 from this state, the engaging portion 98 will be fitted (forcibly inserted) into the next one of the engaging grooves 76 owing to the biasing force of the biasing member 97 at the point in time when one of the engaging grooves 76 becomes positioned directly below the engaging portion 98. In this way, the user can position the cover 70 at predetermined rotational positions in the circumferential direction (the (e.g., eight-see FIG. 10) rotational positions at which the circumferential position of the respective engaging grooves 76 coincide with the engaging portion 98).

To remove the cover 70, the user pulls the manipulation member 91 rearward to shift the engaging portion 98 to the permitting position. In this state, because the lower-side edge portion of the engaging portion 98 is positioned upward of the upper surface of the engaging portions 75, the engaging portion 98 and the engaging portions 75 disengage and rotation of the cover 70 is now permitted. Accordingly, the user can rotate the cover 70 to the insertion position and then remove the cover 70 by pulling the cover 70 off.

Such a rotation-locking mechanism 90 enables the user to use the grinder 10 with the cover 70 fixed at any one of multiple prescribed rotational-angle positions. In the present embodiment, the manipulation member 91 is made of a polymer (resin) and the restricting plate 92 is made of metal. Consequently, it is possible to improve the feel of the manipulation member 91 and increase the durability of the restricting plate 92.

Furthermore, because the cover 70 has the notch portion 79 in the present embodiment, when cutting work is performed using the grinder 10 (e.g., when a cutting wheel is being used as the tool accessory 53), the grinder 10 can be used in an attitude such that the opening of the notch portion 79 opposes the workpiece. According to such a method of use, the cutting depth can be increased as compared to an embodiment in which the radially inward edge portion of the cover 70 has a closed shape. In addition, because the lock plate 73 has the plurality of engaging grooves 76 in the present embodiment, the cover 70 can be mounted in various orientations. Consequently, the user can perform cutting work while holding the grinder 10 in any desired attitude. For example, the user can perform cutting work while holding the grinder 10 in an attitude such that the right-side portion of the grinder 10 faces downward in the vertical direction.

After significant usage, such a rotation-locking mechanism 90 having the above-mentioned configuration may require replacement of the manipulation member 91 and/or the restricting plate 92 for repair. To perform such a replacement, it is necessary to remove the pin 94 and decouple the manipulation member 91 and the restricting plate 92. However, in the state in which the manipulation member 91 has been displaced to the permitting position, the pin 94 is at a position at which it overlaps the gear-shaft-housing portion 22 when viewed in the left-right direction. Consequently, even if the pin 94 is pressed from left to right using a thin rod, the pin 94 cannot be removed from the manipulation member 91 and the restricting plate 92, because the pin 94 will abut on the gear-shaft-housing portion 22 (more specifically, on the left surface defining the recessed portion 22b). Therefore, the present embodiment also provides a configuration for removing the pin 94 from the manipulation member 91 and the restricting plate 92, as will be described in the following.

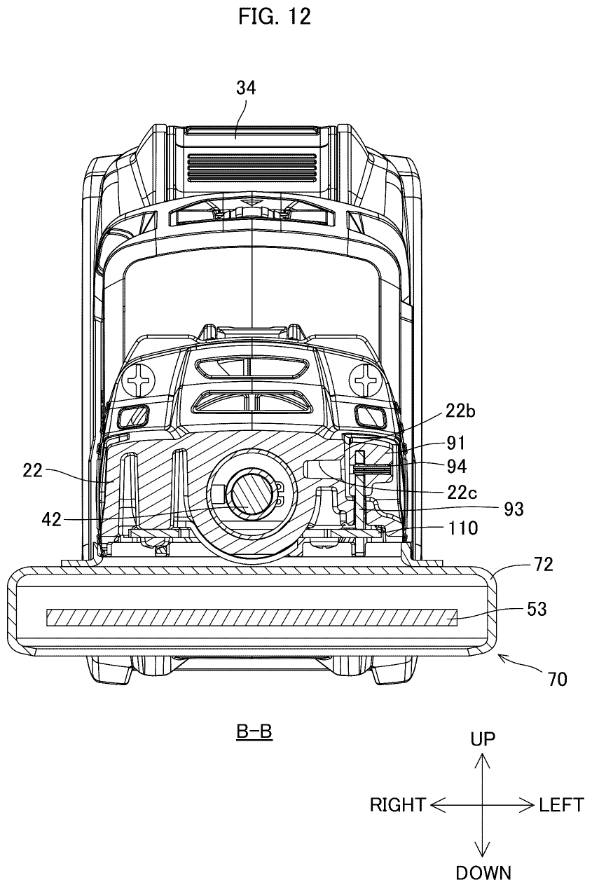

Specifically, as shown in the cross-sectional view portion of FIG. 12, a pin-release hole 22c is formed in a left-side surface of the gear-shaft-housing portion 22 (more specifically, the left-side surface defining the recessed portion 22b). The pin-release hole 22c is a blind hole that extends in the left-right direction and has a larger diameter than the pin 94. In addition, the pin-release hole 22c is located adjacent to the manipulation member 91. In the present embodiment, the position of the pin-release hole 22c is coaxial with the pin 94 when the manipulation member 91 is in its initial position, i.e., the engaged position. The user can easily decouple the manipulation member 91 and the restricting plate 92 by pressing the pin 94 from left to right with a rod into the pin-release hole 22c until the pin 94 is no longer disposed within the manipulation member 91, whereby the manipulation member 91 can be manually removed from the restricting plate 92.

Furthermore, the grinder 10 has a configuration for curtailing rattling of the cover 70 in the up-down direction. The following is a description of such a configuration. As shown in FIG. 4 and FIG. 16, a bottom portion 22d of the gear-shaft-housing portion 22 has the above-described opening 23. The interior and exterior of the gear-shaft-housing portion 22 communicate through the opening 23. The opening 23 is formed for the purpose of mounting the stop ring 84 onto the pin 81 (see FIG. 8) during the manufacture of the grinder 10; that is, after the pin 81 has been inserted into the hole in the right-side surface of the gear-shaft-housing portion 22, the stop ring 84 is mounted on the terminal end of the pin 81. The opening 23 is located rearward of the bearing box 60 in the front-rear direction. In addition, the opening 23 is located between the bearing 46 and the bearing 47 in the front-rear direction. As shown in FIG. 16, four screw bosses 22e, which extend in the up-down direction, are formed in the gear-shaft-housing portion 22 around the opening 23.

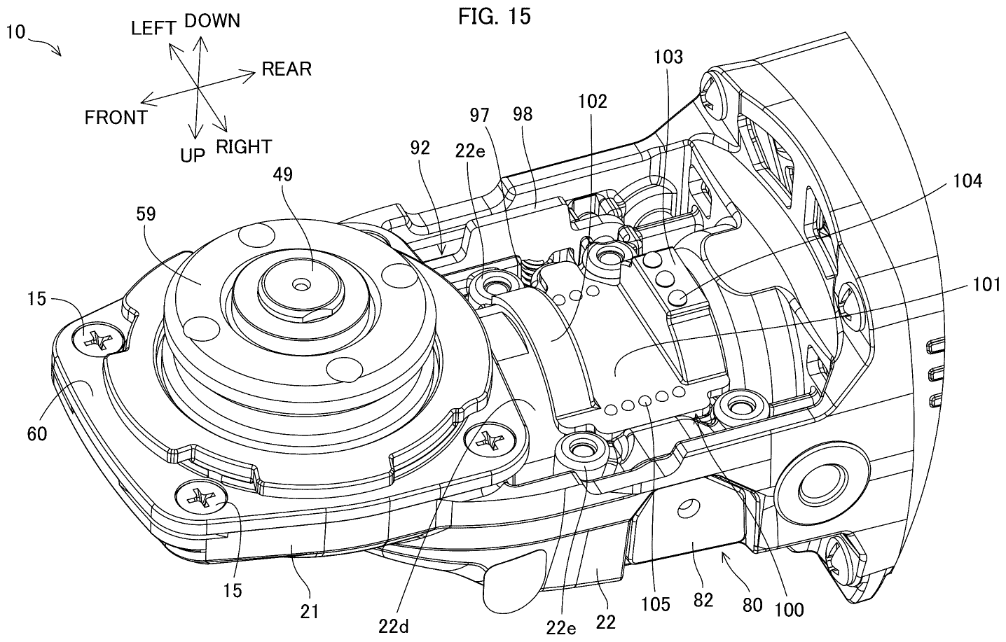

As shown in FIG. 4 and FIG. 15, the opening 23 is closed off by a sealing member 100. As shown in FIG. 15, the sealing member 100 comprises a flat, plate-shaped base 101, a front portion 102 located on the front side of the base 101, and a rear portion 103 located on the rear side of the base 101. The front portion 102 and the rear portion 103 respectively constitute the front-side edge portion and the rear-side edge portion of the sealing member 100. The front portion 102 and the rear portion 103 both have shapes that conform to the arcuate shape of the bottom portion 22d of the gear-shaft-housing portion 22. The rear-side edge portion of the front portion 102 and the front-side edge portion of the rear portion 103 are both closed. The sealing member 100 is disposed so that a right-side edge portion and a left-side edge portion of the base 101 are respectively located (disposed) on flat surfaces 22f, 22g of the gear-shaft-housing portion 22 (see FIG. 16) and so that the front portion 102 and the rear portion 103 conform to the arcuate portion of the bottom portion 22d. The opening 23 is thereby completely closed off (sealed) by the sealing member 100. In addition, the sealing member 100 is disposed at a location (is configured) such that the sealing member 100 does not overlap the screw bosses 22e when viewed in the up-down direction.

As shown in FIG. 15, a lower surface of the rear portion 103 has a flat portion on which a plurality of projections 104 (in the example shown in FIG. 15, three) is formed. Each of the projections 104 projects in a dome shape downward from the flat portion. In addition, the projections 104 are arrayed (aligned) in the left-right direction. The number of projections 104 is not particularly limited and may be any number equal to or greater than one. Projections corresponding to the projections 104 are not formed on the front portion 102. Accordingly, the apex portions of the projections 104 are located more downward than the apex portion of the front portion 102.

As shown in FIG. 15, a plurality of projections 105 (in the example shown in FIG. 15, five on the right side and three on the left side) is formed on the left-side edge portion and the right-side edge portion of the base 101. The projections 105 are located adjacent to the opening 23 and are disposed at locations overlapping the flat surfaces 22f, 22g of the gear-shaft-housing portion 22 (see FIG. 16) when viewed in the up-down direction. Each of the projections 105 projects in a dome shape downward from the base 101. The projections 105 are arrayed in the front-rear direction. The number of projections 105 is not particularly limited and may be any number equal to or greater than one.

As shown in FIG. 14, the grinder 10 further comprises the above-mentioned pressing member 110 that is disposed on (below) the sealing member 100. The pressing member 110 is in the form of a plate and has a center portion 112, a right-side portion 113, and a left-side portion 114. The center portion 112 has a shape that substantially matches that of the base 101 of the sealing member 100. The right-side portion 113 and the left-side portion 114 extend in the front-rear direction from the right-side edge portion and the left-side edge portion, respectively, of the center portion 112. The right-side portion 113 and the left-side portion 114 are disposed at locations overlapping the right-side projections 105 and the left-side projections 105, respectively, of the sealing member 100 when viewed in the up-down direction. The right-side portion 113 and the left-side portion 114 each have two through-holes spaced apart in the front-rear direction. The locations of these through-holes in the horizontal direction respectively coincide with the locations of the four screw bosses 22e in the horizontal direction (see FIG. 15).

As shown in FIG. 14, the pressing member 110 is disposed on the sealing member 100 and fixed to the gear-shaft-housing portion 22 by four screws 17, which are respectively inserted into the four through-holes of the sealing member 100 and into the four screw bosses 22e. The pressing member 110 thereby presses the sealing member 100 upward via the projections 105.

According to the configuration described above, because the opening 23 in the gear-shaft-housing portion 22 is closed off (sealed) by the sealing member 100, ingress of dust, etc. through the opening 23 into the interior of the gear-shaft-housing portion 22 can be blocked (prevented). In addition, as shown in FIG. 4 and FIG. 7, when the cover 70 is mounted so that the rear portion 103 of the sealing member 100 is located directly above the cover upper portion 71, the cover 70 (more specifically, the portion of the cover 70 in the vicinity of the rear-side edge portion thereof) abuts on the projections 104 in the up-down direction. Rattling of the cover 70 in the up-down direction can thereby be curtailed owing to the pressing of the cover 70 against the projections 104. Thus, the sealing member 100 that closes off the opening 23 of the gear-shaft-housing portion 22 for dust prevention purposes, which is necessary when manufacturing the grinder 10, can also be used to stop or minimize (attenuate) rattling of the cover 70. Consequently, it is not necessary to provide an additional component specifically for stopping (attenuating) rattling.

In addition, because the projections 104, which abut on the cover 70 in order to stop rattling, are formed on the rear portion 103 of the sealing member 100, the distance between rotational axis AX2 and the location at which the cover 70 and the sealing member 100 abut each other is larger than an embodiment in which the projections 104 are formed at locations that are closer to the spindle 49 than the rear portion 103. Because rattling of the cover 70 in the up-down direction increases at locations of the cover 70 that are more radially outward from the spindle 49, rattling of the cover 70 in the up-down direction can be more effectively curtailed according to this configuration, because the projections 104 are located close to the radially outer edge of the cover 70.

In addition, because projections are not formed on the front portion 102 of the pressing member 110, the cover 70 and the front portion 102 do not abut each other in the up-down direction, as shown in FIG. 4. Consequently, when the cover 70 is rotated for mounting or removal, the cover 70 is not caught on the front portion 102 and subjected to a rearward force that would cause the front portion 102 to flip up (i.e., sealing performance at the opening 23 is not impaired). It is noted that, even if the rear portion 103 is subjected to a rearward force by the cover 70, in this situation, sealing performance is not impaired because the rear portion 103 will not be displaced in the direction that causes the opening 23 to be opened.

In addition, because both edge portions of the sealing member 100 in the left-right direction are pressed toward the gear-shaft-housing portion 22 by the right-side portion 113 and the left-side portion 114 of the pressing member 110, the sealing performance of the opening 23 by the sealing member 100 can be enhanced. Moreover, because the projections 105 of the sealing member 100 abut on the pressing member 110, the pressing force of the pressing member 110 is concentrated at the projections 105, thereby enabling the sealing performance to be further enhanced.

In this type of grinder, it is common to provide a retaining mechanism (or a horizontal-movement-restricting mechanism) at a location corresponding to the diameter of the cover (in other words, the diameter of the tool accessory) for each model of the grinder (more specifically, models having different tool accessory diameters). In this case, a plurality of covers 70 having different diameters can be selectively mounted on the grinder 10 described above as long as each of the covers 70 has a size such that it is adjacent to the gear housing cover 35 in the left-right direction (i.e., such that the cover 70 does not interfere with (contact) the gear housing cover 35 in the front-rear direction). In FIG. 7, the cover 70 of a tool accessory 53 having a diameter of 125 mm is indicated with a solid line, and the cover 70 of a tool accessory 53 having a diameter of 150 mm is indicated by a dotted line.

Specifically, a plurality of covers 70 having different diameters that each include second protruding portions 77 and second recessed portions 78 of the same shape and size can each be mounted on the bearing box 60 without making design changes to the bearing box 60 or the like. Consequently, the function of restricting (restraining, blocking) movement of the cover 70 in the up-down direction and in the horizontal direction as described above can be obtained regardless of the diameter of the cover 70. In addition, as long as the distance between rotational axis AX2 and the lock plate 73 in the radial direction is the same among the plurality of covers 70 having different diameters, the rattling prevention function described above can be obtained regardless of the diameter of the cover 70. That is, there is no need to make design changes based on the diameter of the cover 70 (the diameter of the tool accessory 53). Accordingly, during the manufacture of the grinder 10, a common main body can be used for a plurality of models of the grinder 10, each comprising a plurality of covers 70 having different diameters. As a result, the cost of manufacturing a plurality of types of the grinder 10 can be reduced.

The grinder 10 further comprises a loosening-preventing mechanism for the lock nut 59. The following is a description of such a mechanism. In the present embodiment, the electric motor 40 has an electric brake function, as was described above. Consequently, when the user manipulates (slides) the manipulation member 36 to stop the electric motor 40, the electric motor 40, and thus the spindle 49, will stop rapidly. At this time, owing to the inertia of the tool accessory 53, there is a risk that the lock nut 59 screwed onto the spindle 49 might loosen (the lock nut 59 may rotate in the direction that causes it to come off the spindle 49). The loosening-preventing mechanism of the lock nut 59 is provided to impede such loosening of the lock nut 59.

As shown in FIG. 5, a lead washer 58 is disposed between the inner flange 54 and the large bevel gear 48 in the up-down direction. The lead washer 58 has a self-locking function to prevent loosening of the lock nut 59. The lead washer 58 is a ring-shaped (annular) member surrounding the spindle 49, and a clearance (annular gap) is provided between the lead washer 58 and the spindle 49 such that the lead washer 58 is rotatable relative to the spindle 49. The lead washer 58 is located radially inward of the bearing retainer 55. The lead washer 58 comprises an upper-side lead washer 58a and a lower-side lead washer 58b.

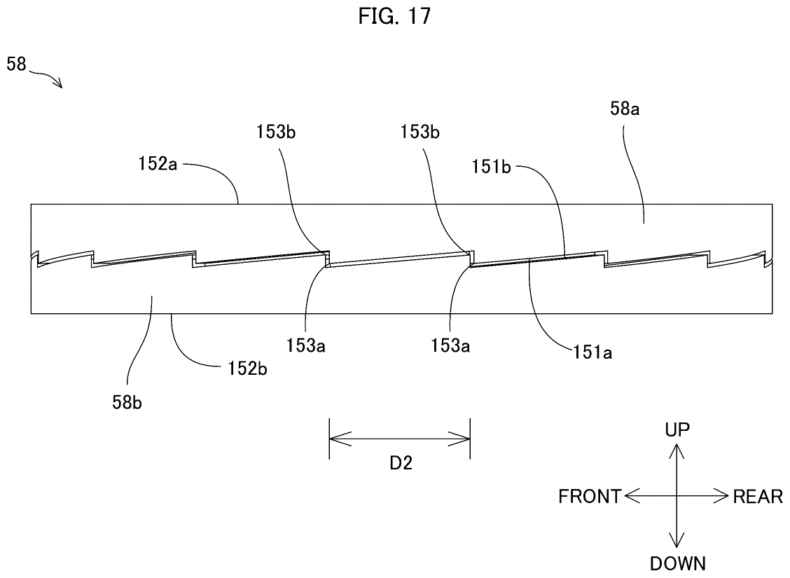

As shown in FIG. 17, the upper-side lead washer 58a has an upper surface 152a, which is an upper-side end surface, and an upper-side cam surface 151a on the side opposite the upper surface 152a. The lower-side lead washer 58b has a lower surface 152b, which is a lower-side end surface, and a lower-side cam surface 151b on the side opposite the lower surface 152b. As shown in FIG. 5, the upper surface 152a of the upper-side lead washer 58a abuts the large bevel gear 48 in the up-down direction. In addition, the lower surface 152b of the lower-side lead washer 58b abuts the inner flange 54 in the up-down direction.

As shown in FIG. 17, the upper-side cam surface 151a and the lower-side cam surface 151b form opposing wedge structures that mesh with each other. Specifically, the upper-side cam surface 151a has a shape such that lead surfaces, which have a constant slope, and steps are repeated along the circumferential direction. The lower-side cam surface 151b has a shape such that lead surfaces, which have the same constant slope as the lead surfaces of the upper-side cam surface 151a, and steps are repeated along the circumferential direction. The slope of the lead surfaces of the upper-side cam surface 151a and the lower-side cam surface 151b is greater than the lead angle of the male-thread portion 49a of the spindle 49. With respect to the wedge shapes of the upper-side cam surface 151a, the points located most downward are also referred to as crests 153a. In addition, with respect to the wedge shapes of the lower-side cam surface 151b, the points located most upward are also referred to as crests 153b.

With such a lead washer 58, when the rotation of the spindle 49 is abruptly stopped by the electric brake function of the electric motor 40, the large bevel gear 48 press-fitted onto the spindle 49 is abruptly stopped, but the inner flange 54, which is not press-fitted onto the spindle 49, continues to rotate due to inertia. At this time, a frictional force acts between the large bevel gear 48 and the upper-side lead washer 58a and between the inner flange 54 and the lower-side lead washer 58b. Consequently, from the state in which the upper-side lead washer 58a and the lower-side lead washer 58b shown in FIG. 17 are enmeshed, relative rotation occurs between the upper-side lead washer 58a and the lower-side lead washer 58b. Specifically, the upper-side lead washer 58a and the lower-side lead washer 58b rotate relative to each other such that the crests 153a of the upper-side lead washer 58a surmount the lower-side cam surface 151b of the lower-side lead washer 58b. The gap between the upper-side cam surface 151a and the lower-side cam surface 151b thereby gradually increases. As a result, the lower-side lead washer 58b is pushed downward by the upper-side lead washer 58a.

Here, as described above, the slope of the lead surfaces of the upper-side cam surface 151a and the lower-side cam surface 151b is greater than the lead angle of the male-thread portion 49a of the spindle 49. Consequently, when relative rotation occurs between the upper-side lead washer 58a and the lower-side lead washer 58b, the female thread formed on the inner surface defining the second through-hole 59a of the lock nut 59 becomes incapable of surmounting the crests of the male-thread portion 49a of the spindle 49. As a result, rotation of the lock nut 59 in the loosening direction is impeded.

The spindle 49 and the inner flange 54 have a structure for effectively exhibiting (performing) a self-locking function by using the relative rotation of the upper-side lead washer 58a and the lower-side lead washer 58b. Specifically, the spindle 49 and the inner flange 54 have sizes and shapes such that, when the inner flange 54 has rotated a prescribed angle relative to the spindle 49, the radially inward edge portion defining the first through-hole 54a of the inner flange 54 and the spindle 49 come into contact, thereby restricting (impeding) further rotation.

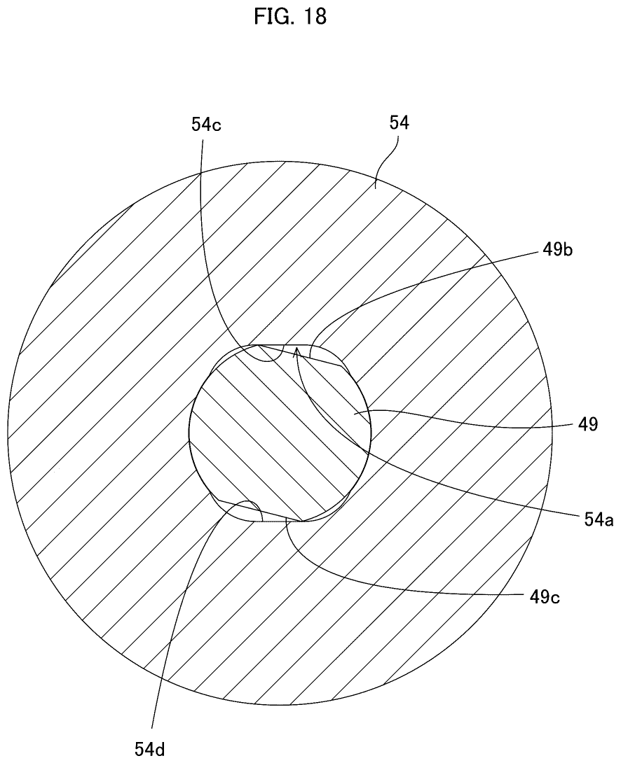

More specifically, as shown in FIG. 18, the spindle 49 has two opposing flat surfaces 49b, 49c in a cross section orthogonal to the up-down direction. In addition, in this cross section, the spindle 49 has two segments having a circular outer shape between the flat surface 49b and the flat surface 49c in the circumferential direction. In addition, the radially inward edge portion defining the first through-hole 54a of the inner flange 54 has two opposing flat surfaces 54c, 54d in a cross section orthogonal to the up-down direction. In this cross section, the radially inward edge portion of the inner flange 54 has two segments having a circular outer shape, which conform to the circular segments of the outer shape of the spindle 49, between the flat surfaces 54c, 54d in the circumferential direction. The flat surfaces 54c, 54d are located at rotational-angle positions substantially corresponding to the flat surfaces 49b, 49c, respectively, of the spindle 49.

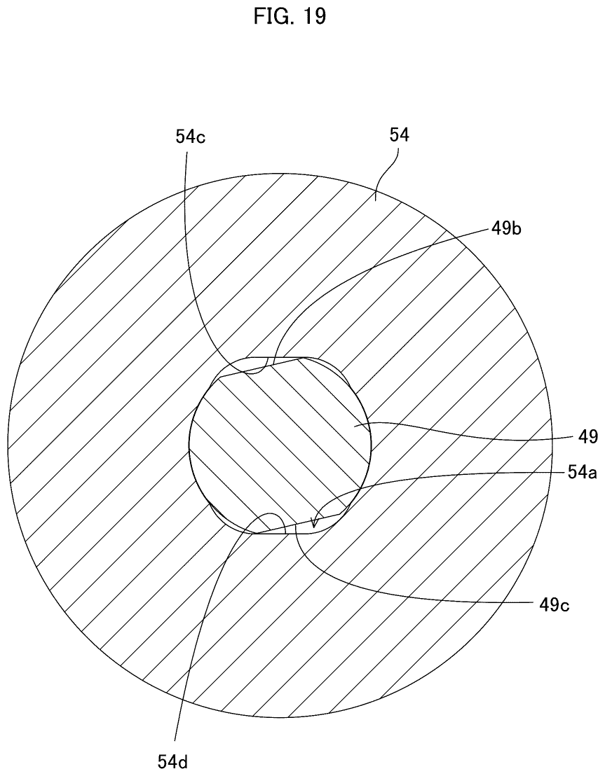

When the electric motor 40 is being driven (energized), the edge portions of the flat surfaces 49b, 49c of the spindle 49 on one side in the circumferential direction come into contact with the flat surfaces 54c, 54d, respectively, of the inner flange 54 as shown in FIG. 18, thereby transmitting the rotational force of the spindle 49 to the inner flange 54. On the other hand, when the rotation of the spindle is abruptly stopped by the electric brake function of the electric motor 40, the inner flange 54 rotates relative to the spindle 49 due to inertia. Focusing solely on the clearance between the spindle 49 and the inner flange 54, the rotation at this time is possible at most until the edge portions of the flat surfaces 49b, 49c of the spindle 49 on the other side in the circumferential direction come into contact with the flat surfaces 54c, 54d, respectively, of the inner flange 54, as shown in FIG. 19. Focusing only on the clearance between the spindle 49 and the inner flange 54, the maximum angle of relative rotation between the two (i.e., the angle of relative rotation between the spindle 49 and the inner flange 54 from the state shown in FIG. 18 to the state shown in FIG. 19) is 26° in the present embodiment.

In the present embodiment, the above-mentioned maximum angle of relative rotation is set to equal to or greater than a rotational angle corresponding to the distance (indicated by D2 in FIG. 17) required for the crests 153a of the upper-side lead washer 58a to just surmount one of the lower-side cam surfaces 151b of the lower-side lead washer 58b. In the present embodiment, the rotational angle corresponding to distance D2 is 22.5°. According to such a setting, a satisfactory self-locking function can be provided by the lead washer 58. Specifically, it is possible to prevent the occurrence of a situation in which the spindle 49 and the inner flange 54 come into contact with each other before the self-locking function provided by the lead washer 58 is fully exerted, thereby making the spindle 49 and the inner flange 54 incapable of rotating further relative to each other and, in turn, making the upper-side lead washer 58a and the lower-side lead washer 58b incapable of rotating relative to each other. In an alternative embodiment, the maximum angle of relative rotation may be 10° or greater and 35° or less, or 10° or greater and 30° or less. In yet another alternative embodiment, the maximum angle of relative rotation may be a rotational angle corresponding to a distance equal to or greater than half of distance D2 and equal to or less than 2 times distance D2, or a rotational angle corresponding to a distance equal to or greater than distance D2 and equal to or less than 1.5 times distance D2.

In the present embodiment, the spindle 49 and the inner flange 54 are both made of an iron alloy. Unichromate plating (i.e. zinc plating followed by chromate treatment) may be applied to the inner flange 54. If the inner flange 54 is subjected to unichromate plating, it is possible to keep the circumferential-direction edge portions of the flat surfaces 49b, 49c of the spindle 49 from digging into the flat surfaces 54c, 54d of the inner flange 54 and to curtail damage to the circumferential-direction edge portions of the flat surfaces 49b, 49c when the circumferential-direction edge portions of the flat surfaces 49b, 49c come into contact with the flat surfaces 54c, 54d, respectively, as shown in FIG. 19.

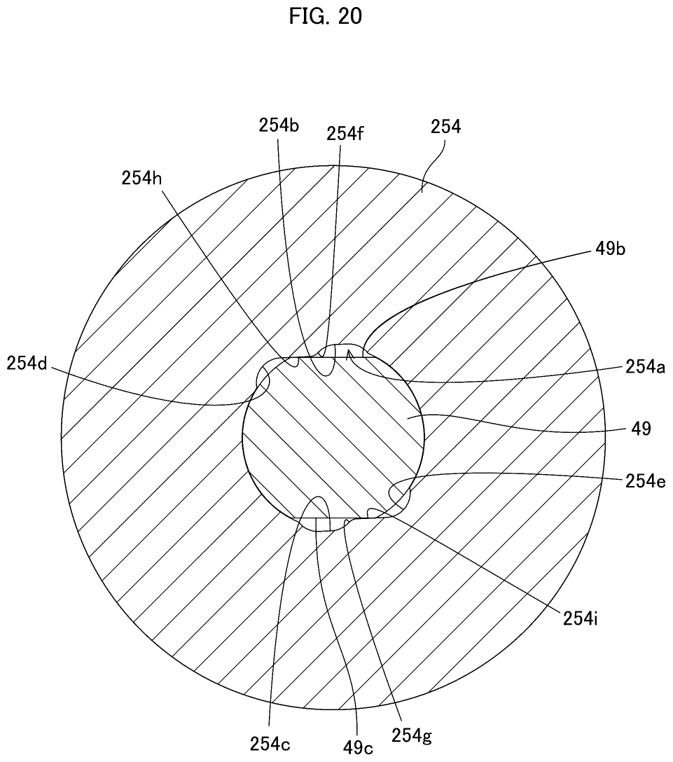

The following is a description of a second embodiment of the present teachings. The grinder 10 according to the second embodiment differs from the first embodiment only in comprising an inner flange 254 instead of the inner flange 54. The following is a description only of the points of difference between the second embodiment and the first embodiment. As shown in FIG. 20, the inner flange 254 has a first through-hole 254a, through which the spindle 49 passes. The radially inward edge portion of the inner flange 254 has two opposing first notch portions 254b, 254c and two opposing second notch portions 254d, 254e in a cross section orthogonal to the up-down direction. Each of the first notch portions 254b, 254c and the second notch portions 254d, 254e has a shape such that the radially inward edge portion of the inner flange 254 is partially notched in the radially outward direction. In this cross section, the radially inward edge of the inner flange 254 has two circular shaped segments, which conform to the two circular-shaped segment of the spindle 49, between the first notch portions 254b, 254c and the second notch portions 254d, 254e in the circumferential direction.

As shown in FIG. 20, when the electric motor 40 is being driven and the spindle 49 is rotating, a second abutting portion 254h of the second notch portion 254d is in face-to-face contact with the flat surface 49b of the spindle 49. Likewise, a second abutting portion 254i of the second notch portion 254e is in face-to-face contact with the flat surface 49c of the spindle 49. The inner flange 254 is thereby capable of rotating together (integrally) with the spindle 49.

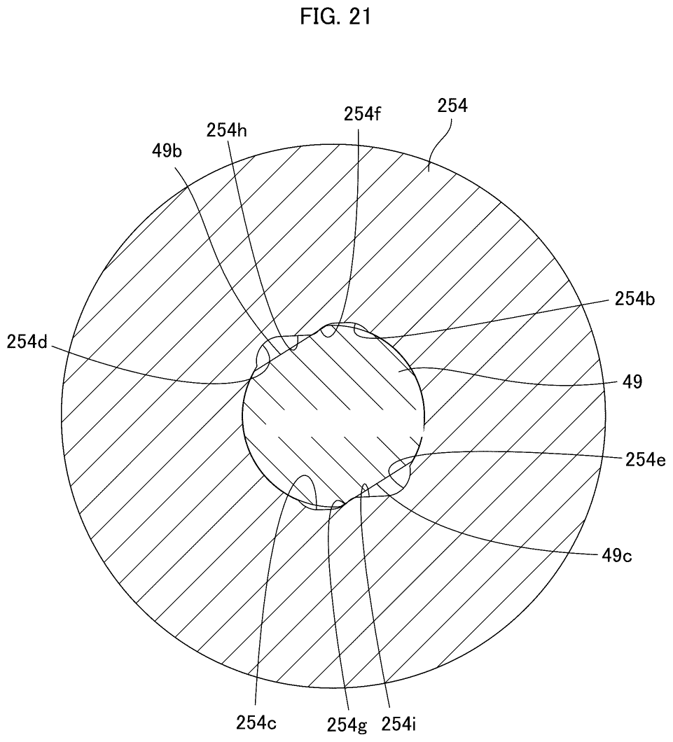

When the rotation of the spindle is abruptly stopped by the electric brake function of the electric motor 40, the inner flange 54 rotates relative to the spindle 49 due to inertia. Focusing solely on the clearance between the spindle 49 and the inner flange 254, the rotation at this time is possible at most until a first abutting portion 254f of the first notch portion 254b comes into face-to-face contact with the flat surface 49b of the spindle 49, as shown in FIG. 21. At this time, similarly, a first abutting portion 254g of the first notch portion 254c comes into face-to-face contact with the flat surface 49c of the spindle 49. Focusing solely on the clearance between the spindle 49 and the inner flange 254, the maximum angle of relative rotation between the two is 26°, as in the first embodiment. Accordingly, as in the first embodiment, sufficient relative rotation between the upper-side lead washer 58a and the lower-side lead washer 58b is permitted, and the self-locking function provided by the lead washer 58 can be effectively exhibited.

According to this configuration, because the spindle 49 and the inner flange 254 come into face-to-face contact, it is possible to curtail deformation of the spindle 49 and/or the inner flange 254 and to keep the spindle 49 and the inner flange 254 from digging into each other when in contact. Because such effects are obtained, unichromate plating need not be applied to the inner flange 254.

Although embodiments have been described above, the above-mentioned embodiments are merely for facilitating understanding of the present teachings and do not limit the scope of the present invention. Modifications and improvements may be made to the present invention without departing from the gist thereof, and the present invention includes such equivalents. In addition, the structural elements described in the claims and the specification may be arbitrarily combined or arbitrarily omitted within a scope such that, e.g., one or more of the problems described above can be at least partially solved or within a scope such that one or more of the effects described above are at least partially exhibited.

For example, the shapes and forms of the components of the grinder 10 described above are merely illustrative examples and can be arbitrarily modified as long as the function of those components is ensured.

The correspondences between the structural elements of the above-mentioned embodiments and the structural elements in the claims are shown below. However, the component elements in the embodiments are merely examples and do not limit the structural elements of the present invention. The grinder 10 is one example of the “grinder.” The front-rear direction is one example of the “first direction.” The up-down direction is one example of the “second direction.” The electric motor 40 is one example of the electric motor. The motor shaft 41 is one example of the “motor shaft.” The spindle 49 is one example of the “final output shaft.” The tool accessory 53 is one example of the “tool accessory.” The first bearing 50 is one example of the “first bearing.” The second bearing 51 is one example of the “second bearing.”

The large bevel gear 48 is one example of the “gear.” The gear housing 20 is one example of the “gear housing.” The first through-holes 27 are one example of the “first through-hole.” The bearing box 60 is one example of the “bearing box.” The second through-holes 68 are one example of the “second through-hole.” The screws 15 are one example of the “screw.” The upper-side edge portions 27a are one example of the “edge portion” of the first through-hole. First straight line L1 is one example of the “first straight line.” Second straight line L2 is one example of the “second straight line.”

### EXPLANATION OF THE REFERENCE NUMBERS

10 Grinder
15 Screw
15a Tip
17 Screw
20 Gear housing
21 Spindle-housing portion
22 Gear-shaft-housing portion
22a Opening
22b Recessed portion
22c Hole
22d Bottom portion
22 Screw boss
22f Flat surface
23 Opening
24 Inner surface
25 Front-side support region
25a Circumferential-direction groove
25b O-ring
26 Rear-side support region
27 First through-hole
27a Upper-side edge portion
28 Countersunk portion
29 Center portion
30 Motor housing
31 Handle housing
32 Rear-portion housing
33 Battery-mounting portion
34 Battery
35 Gear housing cover
36 Manipulation member
40 Electric motor
41 Motor shaft
42 Gear shaft
42a Insertion opening
43 Small bevel gear
44, 45, 46, 47 Bearings
48 Large bevel gear
48a Ring-shaped recessed portion
48b Step portion
49 Spindle
49a Male-thread portion
49b, 49c Flat surfaces
50 First bearing
51 Second bearing
53 Tool accessory
54 Inner flange
54a First through-hole
54b O-ring
54c, 54d Flat surfaces
55 Bearing retainer
56 Circular-tube portion
57 Flange
58 Lead washer
58a Upper-side lead washer
58b Lower-side lead washer
59 Lock nut
59a Second through-hole
60 Bearing box
61 Base
62 Inner surface
63 Step portion
64 Cover mounting portion
65 First protruding portion
66 First recessed portion
67 Groove
68 Second through-hole
69 Through-hole
70 Cover
71 Cover upper portion
72 Cover side portion
73 Lock plate
74 Mount
75 Engaging portion
76 Engaging groove
77 Second protruding portion
78 Second recessed portion
79 Notch portion
80 Shaft-locking mechanism
81 Pin
82 Manipulation member
83 Biasing spring
84 Stop ring
90 Rotation-locking mechanism
91 Manipulation member
92 Restricting plate
93 Coupling portion
94 Pin
95 Pivot shaft portion
96 Pin
97 Biasing member
98 Engaging portion
99 Upper surface
100 Sealing member
101 Base
102 Front portion
103 Rear portion
104, 105 Projections
110 Pressing member
111 Through-hole
112 Center portion
113 Right-side portion
114 Left-side portion
151a Upper-side cam surface
151b Lower-side cam surface
152a Upper surface
152b Lower surface
153a, 153b Crests
254 Inner flange
254b, 254c First notch portions
254d, 254e Second notch portions
254f, 254g First abutting portions
254h, 254i Second abutting portions
L1 First straight line
L2 Second straight line
AX1 Rotational axis
AX2 Rotational axis

1. A grinder comprising:
an electric motor having a motor shaft that extends in a first direction;
a final output shaft that extends in a second direction orthogonal to the first direction and on which a tool accessory is mountable;
a first bearing that supports the final output shaft in a rotatable manner;
a second bearing that also supports the final output shaft in a rotatable manner and is located closer to the tool accessory in the second direction than the first bearing;
at least one gear that is configured to transmit a rotational driving force of the motor shaft to the final output shaft;
a gear housing that at least partially houses the at least one gear and has a first through-hole, which passes through the gear housing in the second direction on the side opposite the electric motor with respect to the final output shaft in the first direction, the first through-hole having a female thread;
a bearing box that is located closer to the tool accessory in the second direction than the gear housing, supports the second bearing, and has at least one second through-hole that passes through the bearing box in the second direction coaxially with the at least one first through-hole; and
a first screw that is threadedly engaged with the first through-hole and is inserted in the direction from the bearing box toward the gear housing to fix the gear housing and the bearing box to each other.

2. The grinder according to claim 1, wherein the first screw is disposed within the first through-hole such that a tip of the first screw reaches a depth having a distance of greater than 0 mm and less than 1 mm from an edge portion on the side of the first through-hole opposite the tool accessory in the second direction.

3. The grinder according to claim 1, wherein an edge portion of the first through-hole on the side opposite the tool accessory in the second direction has a countersunk shape.

4. The grinder according to claim 1, further comprising:
a second first through-hole defined in the gear housing and disposed spaced apart from the first through-hole in a third direction that is orthogonal to the first direction and the second direction;
a second screw inserted into and threadedly engaging the second first through-hole; and
in a cross section passing through the axis of the first screw and the axis of the second screw, edge portions of the first through-hole and the second first through-hole on the side opposite the tool accessory in the second direction are located closer to the tool accessory in the second direction than a center portion of the outer surface of the gear housing between the first through-hole and the second first through-hole.

5. The grinder according to claim 1, wherein:
the side on which the final output shaft is located in the first direction and the side on which the electric motor is located in the first direction are defined as a front side and a rear side, respectively;
the side on which the first bearing is located and the side on which the second bearing is located in the second direction are defined as an upper side and a lower side, respectively;
an access angle is formed by a first straight line, which extends rearward and upward from the front-side and the upper-side edge portion of the tool accessory and is tangent to an outer surface of the gear housing as viewed in a direction orthogonal to the front-rear direction and the up-down direction, and a second straight line, which extends rearward and downward from the front-side and the lower-side edge portion of the tool accessory and is tangent to an outermost surface of a component of on an outer surface of the grinder as viewed in a direction orthogonal to the front-rear direction and the up-down direction; and
the access angle is less than 42°.

6. The grinder according to claim 5, wherein the access angle is 40° or less.

7. The grinder according to claim 2, wherein the edge portion of the first through-hole on the side opposite the tool accessory in the second direction has a countersunk shape.

8. The grinder according to claim 7, further comprising:
a second first through-hole defined in the gear housing and disposed spaced apart from the first through-hole in a third direction that is orthogonal to the first direction and the second direction;
a second screw inserted into and threadedly engaging the second first through-hole; and
in a cross section passing through the axis of the first screw and the axis of the second screw, the edge portions of the first through-hole and the second first through-hole on the side opposite the tool accessory in the second direction are located closer to the tool accessory in the second direction than a center portion of the outer surface of the gear housing between the first through-hole and the second first through-hole.

9. The grinder according to claim 8, wherein:
the side on which the final output shaft is located in the first direction and the side on which the electric motor is located in the first direction are defined as a front side and a rear side, respectively;
the side on which the first bearing is located and the side on which the second bearing is located in the second direction are defined as an upper side and a lower side, respectively;
an access angle is formed by a first straight line, which extends rearward and upward from the front-side and the upper-side edge portion of the tool accessory and is tangent to an outer surface of the gear housing as viewed in a direction orthogonal to the front-rear direction and the up-down direction, and a second straight line, which extends rearward and downward from the front-side and the lower-side edge portion of the tool accessory and is tangent to an outermost surface of a component of on an outer surface of the grinder as viewed in a direction orthogonal to the front-rear direction and the up-down direction; and
the access angle is less than 42°.

10. The grinder according to claim 9, wherein the access angle is 40° or less.

11. A grinder comprising:
an electric motor having a motor shaft that extends in a first direction;
a tool accessory;
a final output shaft that extends in a second direction orthogonal to the first direction and on which the tool accessory is mountable;
a first bearing that supports the final output shaft in a rotatable manner;
a second bearing that also supports the final output shaft in a rotatable manner and is located closer to the tool accessory in the second direction than the first bearing;
at least one gear that is configured to transmit a rotational driving force of the motor shaft to the final output shaft; and
a gear housing that at least partially houses the at least one gear;
wherein:
the side on which the final output shaft is located in the first direction and the side on which the electric motor is located in the first direction are defined as a front side and a rear side, respectively;
the side on which the first bearing is located and the side on which the second bearing is located in the second direction are defined as an upper side and a lower side, respectively;
an access angle is formed by a first straight line, which extends rearward and upward from the front-side and the upper-side edge portion of the tool accessory and is tangent to an outer surface of the gear housing as viewed in a direction orthogonal to the front-rear direction and the up-down direction, and a second straight line, which extends rearward and downward from the front-side and the lower-side edge portion of the tool accessory and is tangent to an outermost surface of a component of on an outer surface of the grinder as viewed in a direction orthogonal to the front-rear direction and the up-down direction; and
the access angle is less than 42°.

12. The grinder according to claim 11, wherein the access angle is 40° or less.

13. The grinder according to claim 12, wherein:
the gear housing has a first through-hole, which passes through the gear housing in the second direction on the side opposite the electric motor with respect to the final output shaft in the first direction, the first through-hole having a female thread;
a bearing box is located closer to the tool accessory in the second direction than the gear housing, supports the second bearing, and has at least one second through-hole that passes through the bearing box in the second direction coaxially with the at least one first through-hole; and
a first screw is threadedly engaged with the first through-hole and is inserted in the direction from the bearing box toward the gear housing to fix the gear housing and the bearing box to each other.

14. The grinder according to claim 13, wherein the first screw is disposed within the first through-hole such that a tip of the first screw reaches a depth having a distance of greater than 0 mm and less than 1 mm from an edge portion on the outer side of the first through-hole opposite the tool accessory in the second direction.
